(19) United States
(12) Patent Application Publication
(10) Pub. No.: US 2026/0162575 A1
(43) Pub. Date: Jun. 11, 2026

(54) DISPLAY DEVICE AND SYSTEM OF TESTING DISPLAY DEVICE

(71) Applicant: LG Display Co., Ltd., Seoul (KR)

(72) Inventors: In KANG, Seoul (KR); DaeSung JUNG, Paju-si (KR)

(73) Assignee: LG Display Co., Ltd., Seoul (KR)

(21) Appl. No.: 19/193,533

(22) Filed: Apr. 29, 2025

(30) Foreign Application Priority Data
Dec. 10, 2024 (KR) 10-2024-0182323

(51) Int. Cl. G09G 3/00; G09G 3/32

(52) U.S. Cl. CPC G09G 3/006; G09G 3/32; G09G 2300/0426; G09G 2300/0842; G09G 2330/10; G09G 2330/12; G09G 2380/10

(57) ABSTRACT

A display device in some examples includes a display panel, a pad unit, and a test circuit. The display panel is connected to a data line, a high potential power line, a low potential power line, and a reference voltage line and has a pixel including a driving transistor and a plurality of transistors disposed. The pad unit includes a data pad connected to the data line, a first power pad connected to the high potential power line, a second power pad connected to the reference voltage line, and a third power pad connected to the low potential power line. The test circuit controls at least one of whether the data line and the reference voltage line are connected and whether the reference voltage line and the second power pad are connected.

### CROSS-REFERENCE TO RELATED APPLICATIONS

This application claims priority to Korean Patent Application No. 10-2024-0182323 filed on Dec. 10, 2024, in the Korean Intellectual Property Office, the entire disclosure of which is hereby expressly incorporated by reference into the present application.

### BACKGROUND

### Field

The present disclosure relates to a display device and a test system of the display device, and more particularly, to a display device which tests a defect of a pixel included in a display device and a test system of the display device.

### Description of the Related Art

As the society enters an information era, a display field which visually expresses electrical information signals has been rapidly developed, and in response to this, various display devices having excellent performances such as thin-thickness, light weight, and low power consumption have been developed. As an example of the display device as described above, there is an organic light emitting display device (OLED), a quantum dot (QD) display device, and the like.

Such a display device can include a display panel in which a plurality of pixels for displaying an image is disposed and each of the plurality of pixels can include a plurality of transistors and at least one light emitting diode. In such a display device, it is needed to test a defect of a pixel.

### SUMMARY OF THE DISCLOSURE

An object to be achieved by the present disclosure is to provide a display device which tests defects of all transistors included in a pixel and a test system for a display device.

Objects of the present disclosure are not limited to the above-mentioned objects, and other objects, which are not mentioned above, can be clearly understood by those skilled in the art from the following descriptions.

A display device according to some example embodiments of the present disclosure includes a display panel which is connected to a data line, a high potential power line, a low potential power line, and a reference voltage line and has a pixel including a driving transistor and a plurality of transistors disposed, a pad unit which includes a data pad connected to the data line, a first power pad connected to the high potential power line, a second power pad connected to the reference voltage line, and a third power pad connected to the low potential power line and a test circuit which controls at least one of whether the data line and the reference voltage line are connected and whether the reference voltage line and the second power pad are connected.

A test system of a display device according to some example embodiments of the present disclosure includes a display panel which is connected to a data line, a high potential power line, a low potential power line, and a reference voltage line and has a pixel including a driving transistor and a plurality of transistors disposed, a pad unit which includes a data pad connected to the data line, a first power pad connected to the high potential power line, a second power pad connected to the reference voltage line, and a third power pad connected to the low potential power line and a test device connected to the pad unit, wherein the test device includes a first input pin which is connected to the first power pad and is applied with a first test signal, a second input pin which is connected to the second power pad and is applied with a second test signal and an output pin connected to the data pad.

Other detailed matters of the example embodiments are included in the detailed description and the drawings.

According to the example embodiments of the present disclosure, the display device and the test system of a display device provide a test signal through at least one input pin connected to a power pad, among a plurality of pads included in the display device and receive a feedback signal through an output pin which is connected to a data pad via a pixel. Further, whether there is an abnormal driving or a defect of the display device (for example, a pixel) can be tested based on a current value of the feedback signal.

Here, according to aspects of the present disclosure, the display device can include a test circuit which controls a current path of a test signal which is supplied from an input pin of a test device according to a test mode. Accordingly, the test system according to the example embodiments of the present disclosure controls a signal level of various signals (for example, a first scan signal, a second scan signal, and an emission signal) applied to a pixel and a control signal which is supplied to a plurality of test switches included in a test circuit. By doing this, the test system can test a pixel through a first feedback signal along a first current path or test a pixel through a second feedback signal along a second current path which is different from the first current path.

As described above, the test system according to the example embodiments of the present disclosure can test whether there is abnormal driving or a defect of all transistors (for example, a driving transistor and a plurality of switching transistors) included in a pixel of a display device using a feedback signal along various current paths.

The effects according to the present disclosure are not limited to the contents exemplified above, and more various effects are included in the present disclosure.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is an exemplary diagram of a display device according to example embodiments of the present disclosure;

FIG. 2 is a block diagram illustrating a display device according to example embodiments of the present disclosure;

FIGS. 3A and 3B are circuit diagrams illustrating an example of a pixel included in the display device of FIG. 2;

FIG. 4 is a waveform chart for explaining an example of an operation of the pixel of FIG. 3A;

FIG. 5 is a circuit diagram illustrating another example of a pixel included in the display device of FIG. 2;

FIGS. 6A and 6B are waveform charts for explaining an example of an operation of the pixel of FIG. 5;

FIGS. 7 and 8 are cross-sectional views illustrating a part of a display device according to example embodiments of the present disclosure;

FIG. 9 is a view for explaining an example of a placement structure of a gate driver included in the display device of FIG. 2;

FIG. 10 is a plan view schematically illustrating a display device according to example embodiments of the present disclosure;

FIG. 11 is a plan view of a display device according to example embodiments of the present disclosure;

FIGS. 12 and 13 are views illustrating a test system of a display device according to example embodiments of the present disclosure;

FIGS. 14A and 14B are views for explaining an example of an operation of testing a display device according to a first test mode by the test system of the display device of FIGS. 12 and 13; and

FIGS. 15A and 15B are views for explaining an example of an operation of testing a display device according to a second test mode the a test system of the display device of FIGS. 12 and 13.

### DETAILED DESCRIPTION OF THE EMBODIMENTS

Advantages and characteristics of the present disclosure and methods of achieving the advantages and characteristics will be clear by referring to example embodiments described below in detail together with the accompanying drawings. However, the present disclosure is not limited to the example embodiments disclosed herein but will be implemented in various forms. The example embodiments are provided by way of example only so that those skilled in the art can fully understand the disclosures of the present disclosure and the scope of the present disclosure.

The shapes, sizes, ratios, angles, numbers, and the like illustrated in the accompanying drawings for describing the example embodiments of the present disclosure are merely examples, and the present disclosure is not limited thereto. Like reference numerals generally denote like elements throughout the specification. Further, in the following description of the present disclosure, a detailed explanation of known related technologies can be omitted to avoid unnecessarily obscuring the subject matter of the present disclosure. The terms such as “including,” “having,” and “consist of” used herein are generally intended to allow other components to be added unless the terms are used with the term “only”. Any references to singular can include plural unless expressly stated otherwise. Further, the term “can” fully encompasses all the meanings and coverages of the term “may” and vice versa.

In describing components of the example embodiment of the present disclosure, terminologies such as first, second, A, B, (a), (b), and the like can be used. These terminologies are used to distinguish a component from the other component, but a nature, an order, or the number of the components is not limited by the terminology. When a component is “linked”, “coupled”, or “connected” to another component, the component can be directly linked or connected to the other component. However, unless specifically stated otherwise, it should be understood that a third component can be interposed between the components which can be indirectly linked or connected.

When the position relation between two parts is described using the terms such as “on”, “above”, “below”, and “next”, one or more parts can be positioned between the two parts unless the terms are used with the term “immediately” or “directly”.

Although the terms “first”, “second”, and the like are used for describing various components, these components are not confined by these terms. These terms are merely used for distinguishing one component from the other components and may not define order or sequence. Therefore, a first component to be mentioned below can be a second component in a technical concept of the present disclosure.

The features of various embodiments of the present disclosure can be partially or entirely adhered to or combined with each other and can be interlocked and operated in technically various ways, and the embodiments can be carried out independently of or in association with each other.

The following embodiments of the present disclosure will be described focusing on the organic light emitting display device. However, embodiments of the present disclosure are not limited to organic light emitting display devices and can be applied to various electroluminescent displays. For example, the electroluminescent display apparatus can use an organic light emitting diode (OLED) display apparatus, a quantum dot light emitting diode display apparatus, or an inorganic light emitting diode display apparatus. All the components of each display apprataus and each display device according to all embodimnets of the present disclosure are operatively coupled and configured.

Hereinafter, example embodiments of the present disclosure will be described in detail with reference to accompanying drawings.

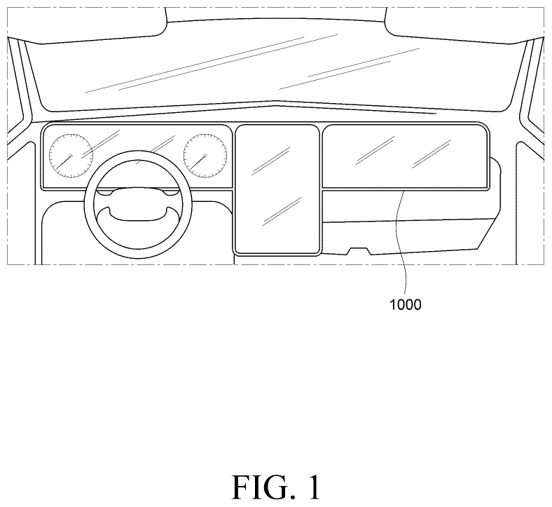

FIG. 1 is an exemplary diagram of a display device according to example embodiments of the present disclosure.

Referring to FIG. 1, a display device 1000 can be disposed in at least a part of a dashboard of a vehicle. The dashboard of the vehicle can include a configuration disposed in a front surface of front seats (for example, a driver seat and a front passenger seat) of the vehicle. For example, on the dashboard of the vehicle, an input configuration for manipulating various functions (for example, an air-conditioner, an audio system, or a navigation system) in the vehicle can be disposed.

The display device 1000 is disposed on the dashboard of the vehicle to operate as an input unit which manipulates at least some of various functions of the vehicle. The display device 1000 can provide various information related to the vehicle, for example, operation information of the vehicle (for example, a current speed of the vehicle, a remaining fuel amount, or a mileage) or information about parts of the vehicle (for example, a damage level of a vehicle tire).

The display device 1000 can be disposed across the driver seat and the front passenger seat disposed in the front seats of the vehicle. A user of the display device 1000 can include a driver of the vehicle and a passenger riding on the front passenger seat. Both the vehicle driver and the passenger can use the display device 1000.

At least a part of the display device 1000 is illustrated in FIG. 1. The display device 1000 illustrated in FIG. 1 can represent a display panel, among various configurations included in the display device 1000. Specifically, for example, the display device 1000 illustrated in FIG. 1 can represent at least a part of an active area and a non-active area of the display panel. Among the configurations of the display device 1000, configurations other than the parts illustrated in FIG. 1 can be mounted inside the vehicle (or at least a part of the inside of the vehicle).

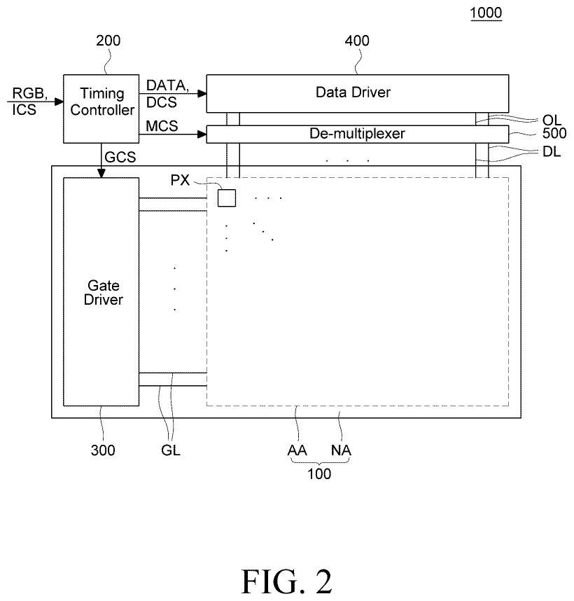

FIG. 2 is a block diagram illustrating a display device according to example embodiments of the present disclosure.

The display device 1000 according to the example embodiments of the present disclosure can be applied to the electroluminescent display device. The electroluminescent display device can use an organic light emitting diode (OLED) display device, a quantum dot light emitting diode display device, or an inorganic light emitting diode display device, but is not limited thereto.

Referring to FIG. 2, a display device 1000 according to example embodiments of the present disclosure can include a display panel 100, a timing controller 200, a gate driver 300, and a data driver 400. In an example embodiment, the display device 1000 can include a de-multiplexer 500 disposed between the data driver 400 and the display panel 100 or between the data driver 400 and the plurality of data lines DL.

The display panel 100 can generate images to be provided to the user. For example, the display panel 100 can include an active area AA (or display area) in which an image is displayed and a non-active area NA (or non-display area) located at the outside of the active area AA. In the non-active area NA, various signal lines and the gate driver 300 can be disposed. The non-active area NA can surround the active area AA entirely or only in some part(s).

In the active area AA of the display panel 100, a plurality of pixels PX each including a pixel circuit can be disposed. Each of the plurality of pixels PX is connected to a corresponding gate line GL and a corresponding data line DL to display images in response to a gate signal supplied to the gate line GL and a data signal supplied to the data line DL.

The timing controller 200 can control the gate driver 300, the data driver 400, and the de-multiplexer 500 based on input image RGB and an input control signal ICS supplied from the outside (for example, a host system). For example, the input control signal ICS can include timing signals, such as a horizontal synchronization signal, a vertical synchronization signal, a data enable signal, and a clock signal and the timing controller 200 can generate a gate control signal GCS, a data control signal DCS, and a multiplexer (MUX) control signal MCS based on the input control signal ICS. The gate control signal GCS can be supplied to the gate driver 300, the data control signal DCS can be supplied to the data driver 400, and the MUX control signal MCS can be supplied to the de-multiplexer 500.

Further, the timing controller 200 realigns an input image RGB with a digital video data format in accordance with a resolution of the display panel 100 to generate image data DATA and provide the image data to the data driver 400.

The gate driver 300 can generate a gate signal based on the gate control signal GCS and output the gate signal to the plurality of gate lines GL. For example, the gate driver 300 can sequentially output the gate signal to the plurality of gate lines GL in the unit of pixel rows. To this end, the gate driver 300 can include a shift register or a level shifter. The gate control signal GCS can include a start signal, a plurality of clock signals, and a reset signal for generating gate signals.

In the example embodiment, the gate driver 300 can generate a scan signal and an emission signal based on the gate control signal GCS. For example, the gate driver 300 can include at least one scan driver and at least one emission signal driver. The scan driver can generate a scan signal in a row sequential manner to drive at least one scan line connected to each pixel row to supply the scan signal to a plurality of scan lines. The emission signal driver can generate an emission signal in a row sequential manner to drive at least one or more emission signal lines connected to each pixel row to supply the emission signal to the plurality of emission signal lines.

According to an example embodiment, the gate driver 300 is formed in a thin film pattern when a substrate of the display panel 100 is manufactured to be embedded on the non-active area NA in a gate-driver in panel (GIP) manner. In the meantime, even though in FIG. 2, only one gate driver 300 is disposed on the non-active area NA of the display panel 100, this is just illustrative, but the example embodiment of the present disclosure is not limited thereto. For example, the gate driver 300 is divided into a plurality of units to be each disposed on the non-active area NA located at least two side surfaces of the display panel 100.

However, the example embodiment of the present disclosure is not limited thereto and the gate driver 300 is disposed on the active area AA of the display panel 100 together with the pixel PX to supply a gate signal to the pixel PX. For example, the gate driver 300 can be disposed in the display panel 100 in a gate-driver in active area (GIA) manner.

The data driver 400 converts digital image data DATA supplied from the timing controller 200 into an analog data signal based on the data control signal DCS to supply the converted analog data signal to the plurality of output lines OL.

In the meantime, the plurality of output lines OL to which a data signal output from the data driver 400 is supplied can be connected to the plurality of data lines DL through the de-multiplexer 500.

The data driver 400 can be connected to a bonding pad of the display panel 100 in a chip on glass (COG) manner or can be directly disposed on the display panel 100. According to the example embodiment, the data driver 400 can be disposed to be integrated with the display panel 100. Further, the data driver 400 can be disposed in a chip on film (COF) manner.

The de-multiplexer 500 time-divides a data signal output from the data driver 400 using a plurality of MUX transistors (or a plurality of MUX switches) to supply the time-divided data signal to the plurality of data lines DL. For example, the plurality of MUX transistors included in the de-multiplexer 500 can be connected between the plurality of output lines OL and the plurality of data lines DL. The number of channels of the data driver 400 can be reduced by such a de-multiplexer 500.

In one example embodiment, one pixel PX can include a plurality of sub pixels which emits different color light. For example, one pixel PX uses three sub pixels to implement blue, red, and green. However, it is not limited thereto, and in some cases, the pixel PX can further include a sub pixel for further implementing a specific color, for example, white. In the meantime, in the pixel PX, an area which implements blue can be referred to as a blue sub pixel, an area which implements red can be referred to as a red sub pixel, and an area which implements green can be referred to as a green sub pixel.

According to the example embodiment, when the display panel 100 is used for the vehicle which has been described with reference to FIG. 1, a field of view of at least a partial area of the display panel 100 needs to be restricted according to the user's request. For example, images displayed in a region of an active area AA of the display panel 100 which provides an entertainment function and seat information for the passenger sitting on the front passenger seat can interrupt the driving of the driver. Accordingly, according to the user's request, a field of view of the image displayed in the corresponding area needs to be restricted.

To this end, according to the example embodiment, each of the plurality of pixels PX can include a first light emitting diode and a second light emitting diode which emit the same color light. Each of the plurality of pixels PX can include a first optical member which reflects light from the first light emitting diode to a specific direction and a second optical member which reflects light from the second light emitting diode to a specific direction. For example, the first optical member and the second optical member can be implemented as lenses, but the example embodiment of the present disclosure is not limited thereto. For example, the first optical member can be disposed in an optical area in which light is provided in a first range to form a first viewing angle and the second optical member can be disposed in an optical area in which light is provided in a second range to form a second viewing angle. The first range can be larger than the second range. Therefore, the first optical member and the second optical member can restrict a viewing angle of each of the plurality of pixels PX.

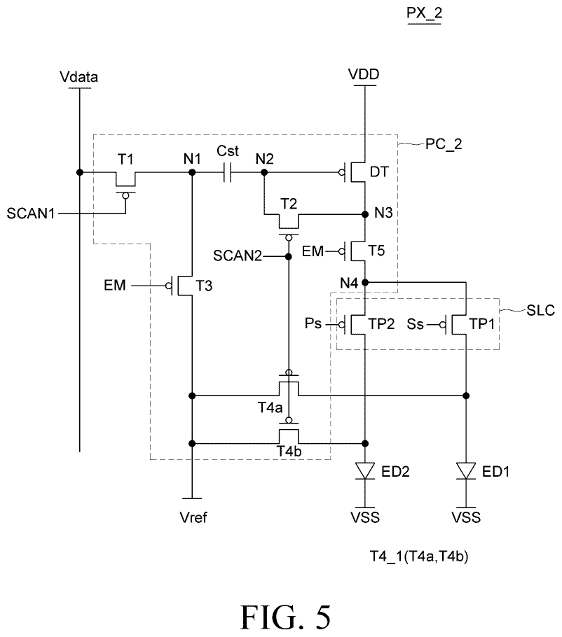

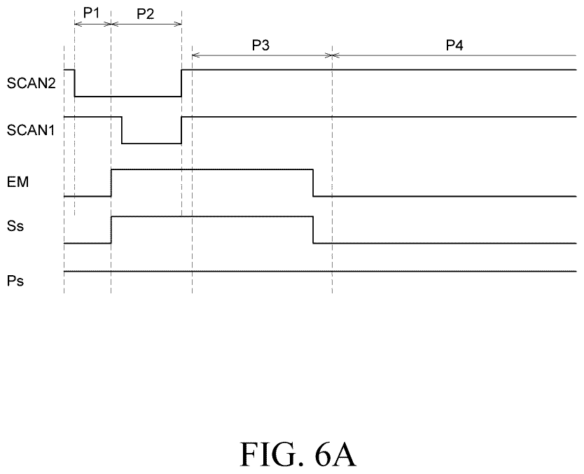

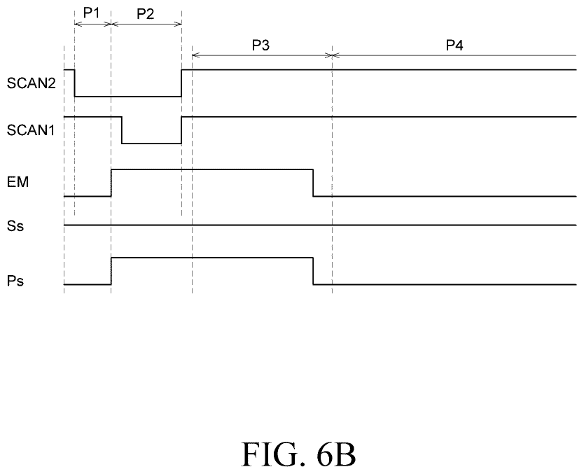

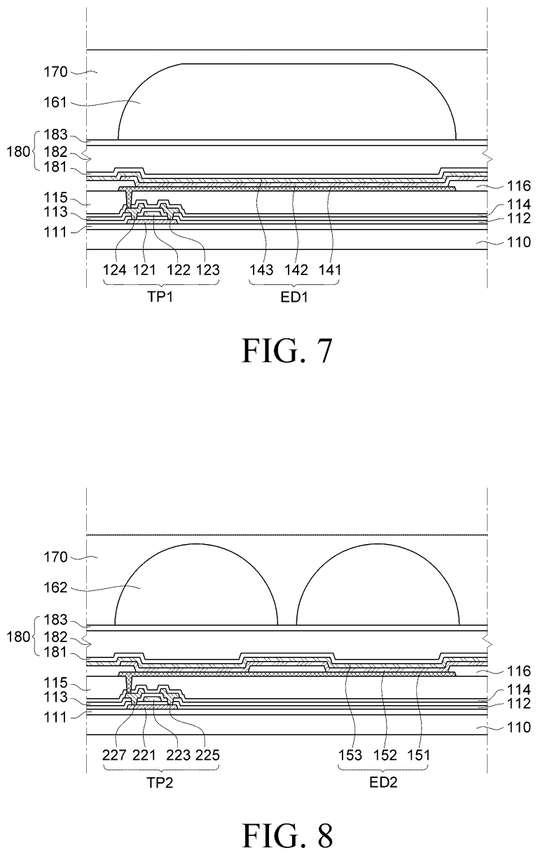

Here, in order to restrict the field of view of an image which is displayed in a specific region as described above, each pixel PX included in the display panel 100 can be driven in a first mode or a second mode according to the driving mode. For example, when the pixel PX is driven in the first mode, a first light emitting diode included in a pixel PX emits light based on a selection signal to provide light from the first light emitting diode in a first range through the first optical member, to form a first viewing angle, for example, a wide viewing angle. For example, when the pixel PX is driven in the second mode, a second light emitting diode included in a pixel PX emits light based on a selection signal to provide light from the second light emitting diode in a second range through the second optical member, to form a second viewing angle, for example, a narrow viewing angle. Here, the first mode can correspond to a mode in which the pixel PX is controlled in a wide field-of-view mode (share mode) and the second mode can correspond to a mode in which the pixel PX is driven in a narrow field-of-view mode (private mode). The operation of the pixel PX in a first mode and a second mode will be described in more detail with reference to FIGS. 5 to 6B and the first optical member and the second optical member will be described in more detail below with reference to FIGS. 7 and 8.

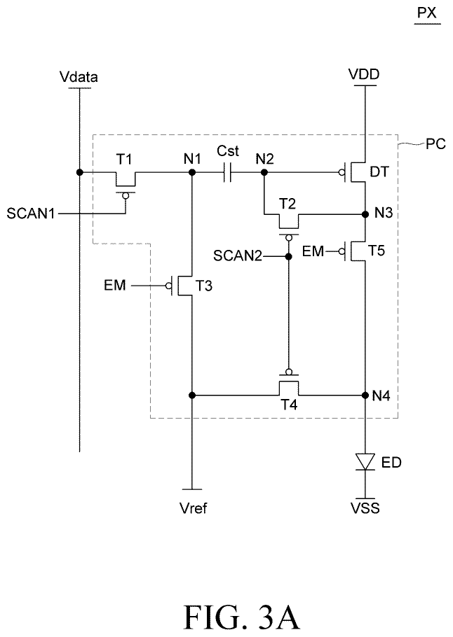

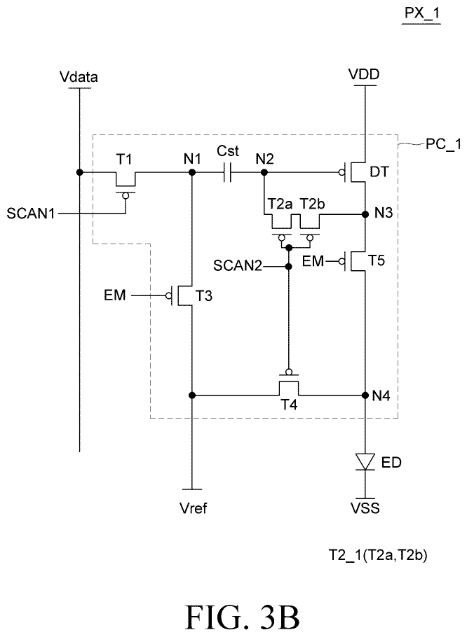

FIGS. 3A and 3B are circuit diagrams illustrating an example of a pixel included in the display device of FIG. 2.

Here, a pixel PX illustrated in FIG. 3A and a pixel PX_1 illustrated in FIG. 3B represent an example of the pixel PX included in the display device 1000 which has been described with reference to FIG. 2, respectively.

Referring to FIG. 3A, the pixel PX according to the example embodiment of the present disclosure can include a pixel circuit PC and a light emitting diode ED connected to the pixel circuit PC.

The pixel circuit PC can include a driving transistor DT, a plurality of transistors T1 to T5, and a storage capacitor Cst.

The driving transistor DT can control a driving current applied to the light emitting diode ED in accordance with a source-gate voltage. The driving transistor DT can include a source electrode connected to a high potential power line which supplies a high potential power voltage VDD, a gate electrode connected to a second node N2, and a drain electrode connected to a third node N3.

A first transistor T1 can apply a data voltage Vdata to the first node N1 from the data line DL. The first transistor T1 can include a source electrode connected to the data line DL, a drain electrode connected to the first node N1, and a gate electrode connected to a first scan line to which a first scan signal SCAN1 is applied. The first transistor T1 can be turned on or turned off by the first scan signal SCAN1. Accordingly, the first transistor T1 can apply a data signal Vdata supplied from the data line DL to the first node N1, in response to a low level of first scan signal SCAN1 which is a turn-on level.

A second transistor T2 can form a diode connection of the gate electrode and the drain electrode of the driving transistor DT. The second transistor T2 can include a drain electrode connected to a second node N2, a source electrode connected to a third node N3, and a gate electrode connected to a second scan line to which a second scan signal SCAN2 is applied. The second transistor T2 can be turned on or turned off by the second scan signal SCAN2. Therefore, the second transistor T2 can form a diode connection of the gate electrode and the drain electrode of the driving transistor DT in response to a low level of second scan signal SCAN2 which is a turn-on level.

In one example embodiment, the second transistor T2 can include a plurality of sub transistors which is connected in series. For example, further referring to FIG. 3B, a second transistor T2_1 included in a pixel circuit PC_1 of the pixel PX_1 can include first and second sub transistors T2a and T2b which are connected in series. Each of the first and second sub transistors T2a and T2b can include a gate electrode which is commonly connected to the second scan line (for example, it is referred to as a dual gate structure). Accordingly, the current leakage by the second transistor T2 can be minimized.

Referring to FIG. 3A again, a third transistor T3 can apply a reference voltage Vref to the first node N1. The third transistor T3 can include a source electrode which is connected to the reference voltage line which supplies the reference voltage Vref, a drain electrode which is connected to the first node N1, and a gate electrode which is connected to the emission signal line to which the emission signal EM is applied. The third transistor T3 can be turned on or turned off by the emission signal EM. Accordingly, the third transistor T3 can transmit the reference voltage Vref to the first node N1 in response to a low level of emission signal EM which is a turn-on level.

A fourth transistor T4 can apply a reference voltage Vref to a fourth node N4 which is an anode electrode of the light emitting diode ED. The fourth transistor T4 can include a source electrode connected to the reference voltage line which supplies the reference voltage Vref, a drain electrode connected to the fourth node N4, and a gate electrode connected to a second scan signal line to which a second scan signal SCAN2 is applied. The fourth transistor T4 can be turned on or turned off by the second scan signal SCAN2. Therefore, the fourth transistor T4 can apply the reference voltage Vref to the fourth node N4, for example, the anode electrode of the light emitting diode ED in response to the low level of second scan signal SCAN2 which is a turn-on level.

A fifth transistor T5 can form a current path between the driving transistor DT and the light emitting diode ED. The fifth transistor T5 can include a source electrode connected to the third node N3, a drain electrode connected to the fourth node N4, and a gate electrode connected to the emission signal line to which an emission signal EM is applied. The fifth transistor T5 can be turned on or turned off by the emission signal EM. Therefore, the fifth transistor T5 can electrically connect the third node N3 and the fourth node N4 in response to a low level of emission signal EM which is a turn-on level to form a current path between the driving transistor DT and the light emitting diode ED.

The storage capacitor Cst can include a first electrode connected to the first node N1 and a second electrode connected to the second node N2. For example, one electrode of the storage capacitor Cst can be connected to the gate electrode of the driving transistor DT and the other electrode of the storage capacitor Cst can be connected to the first transistor T1. The storage capacitor Cst stores a predetermined voltage to constantly maintain a voltage of the gate electrode of the driving transistor DT while the light emitting diode ED emits light.

The light emitting diode ED is connected to the pixel circuit PC to emit light by a driving current which is controlled by the pixel circuit PC. The light emitting diode ED can be connected between the fifth transistor T5 and the low potential power line which supplies a low potential power voltage VSS. For example, the anode electrode of the light emitting diode ED can be connected to the fourth node N4 and the cathode electrode can be connected to the low potential power line.

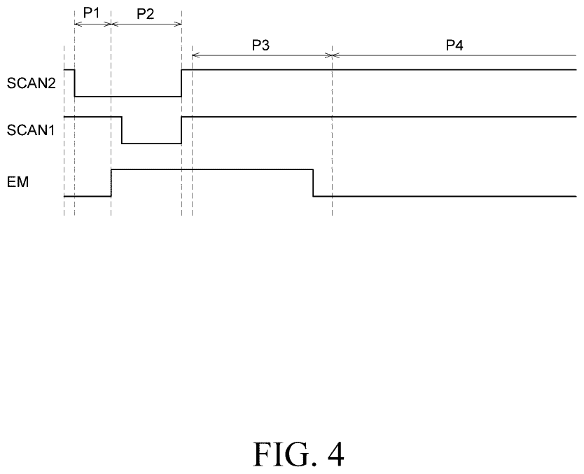

FIG. 4 is a waveform chart for explaining an example of an operation of the pixel of FIG. 3A.

Referring to FIGS. 3A and 4, during an initialization period P1, a low level of second scan signal SCAN2 and a low level of emission signal EM can be output. The second transistor T2 and the fourth transistor T4 can be turned on by the low level of second scan signal SCAN2 and the third transistor T3 and the fifth transistor T5 can be turned on by the low level of emission signal EM.

The first node N1 can be initialized to the reference voltage Vref through the turned-on third transistor T3 and a voltage of the anode electrode of the light emitting diode ED can be initialized to the reference voltage Vref through the turned-on fourth transistor T4.

Further, the driving transistor DT can form a diode connection through the turned-on second transistor T2 to short the gate electrode and the drain electrode of the driving transistor DT so that the driving transistor DT can operate as a diode.

The reference voltage Vref which is transmitted to the anode electrode of the light emitting diode ED, for example, the fourth node N4, through the turned-on fourth transistor T4 is transmitted to the third node N3 and the second node N2 through the turned-on fifth transistor T5. Therefore, the third node N3 and the second node N2 can be initialized to the reference voltage Vref.

Next, during a sampling period P2, the low level of first scan signal SCAN1 and the low level of second scan signal SCAN2 can be output and the emission signal EM can be output at a high level. The third transistor T3 is turned off by a high level of emission signal EM and the first transistor T1 is turned on by the low level of first scan signal SCAN1, simultaneously, to transmit the data signal Vdata to the first node N1.

The driving transistor DT can be diode-connected by the turned-on second transistor T2 and a difference voltage of the high potential power voltage VDD and the threshold voltage is sampled to be supplied to the second node N2.

In the meantime, in the sampling period P2, the fifth transistor T5 can be turned off by the high level of emission signal EM.

Next, during a holding period P3, the first scan signal SCAN1 and the second scan signal SCAN2 can be output at a high level and all the first transistor T1, the second transistor T2, and the fourth transistor T4 can be turned off. However, even though the first transistor T1 is turned off, the data signal Vdata which has been input in the previous period (for example, a sampling period P2) can be maintained by the storage capacitor Cst.

Finally, the low level of emission signal EM can be output in the emission period P4. The reference voltage Vref is applied to the first node N1 through the third transistor T3 which is turned on by the low level of emission signal EM and the voltage of the first node N1 can become the difference voltage of the reference voltage Vref and the data signal Vdata. Such voltage fluctuation can be reflected to the second node N2. The gate-source voltage of the driving transistor DT can be set to a value Vdata−Vref+Vth obtained by subtracting the reference voltage Vref from the data signal Vdata and then adding the threshold voltage Vth to control the driving current.

The driving current from the driving transistor DT is supplied to the light emitting diode ED through the fifth transistor T5 which is turned on by the low level of emission signal EM so that the light emitting diode ED can emit light.

FIG. 5 is a circuit diagram illustrating another example of a pixel included in the display device of FIG. 2.

Here, a pixel PX_2 illustrated in FIG. 5 represents another example of the pixel PX included in the display device 1000 which has been described with reference to FIG. 2. For example, as described with reference to FIGS. 1 and 2, when the display panel 100 is used for a vehicle which has been described with reference to FIG. 1 so that the display device 1000 is controlled to restrict a field of view of an image displayed in a specific region according to a driving mode, the pixel PX included in the display device 1000 can be implemented as a pixel PX_2 illustrated in FIG. 5.

In the meantime, the pixel PX_2 illustrated in FIG. 5 represents a modified example for the pixel PX or PX_1 which has been described with reference to FIGS. 3A and 3B, with regard to the fourth transistor T4_1, a selection circuit SLC, and a plurality of light emitting diodes ED1 and ED2 included in the pixel circuit PC_2. Accordingly, a repeated description with the content which has been described with reference to FIGS. 3A and 3B will not be repeated.

Referring to FIG. 5, the pixel PX_2 according to the example embodiment of the present disclosure can include a pixel circuit PC_2, a selection circuit SLC, and a plurality of light emitting diodes ED1 and ED2.

The pixel circuit PC_2 can include a driving transistor DT, a plurality of transistors T1 to T5, and a storage capacitor Cst.

A fourth transistor T4_1 included in the pixel circuit PC_2 can include a third sub transistor T4a and a fourth sub transistor T4b.

The third sub transistor T4a can apply the reference voltage Vref to the anode electrode of the first light emitting diode ED1. The third sub transistor T4a can include a source electrode connected to the reference voltage line which supplies the reference voltage Vref, a drain electrode connected to the anode electrode of the first light emitting diode ED1, and a gate electrode connected to a second scan line to which a second scan signal SCAN2 is applied. The third sub transistor T4a can be turned on or turned off by the second scan signal SCAN2. Therefore, the third sub transistor T4a can apply the reference voltage Vref to the anode electrode of the first light emitting diode ED1 in response to the low level of second scan signal SCAN2 which is a turn-on level.

The fourth transistor T4b can apply the reference voltage Vref to the anode electrode of the second light emitting diode ED2. The fourth sub transistor T4b can include a source electrode connected to the reference voltage line which supplies the reference voltage Vref, a drain electrode connected to the anode electrode of the second light emitting diode ED2, and a gate electrode connected to a second scan line to which a second scan signal SCAN2 is applied. The fourth sub transistor T4b can be turned on or turned off by the second scan signal SCAN2. Therefore, the fourth sub transistor T4b can apply the reference voltage Vref to the anode electrode of the second light emitting diode ED2 in response to the low level of second scan signal SCAN2 which is a turn-on level.

Further, the fifth transistor T5 can form a current path between the driving transistor DT and any one light emitting diode among the plurality of light emitting diodes ED1 and ED2. For example, the drain electrode of the fifth transistor T5 is connected to the selection circuit SLC, for example, the fourth node N4, to electrically connect the third node N3 and the fourth node N4 in response to a low level of emission signal EM which is a turn-on level to form a current path between the driving transistor DT and any one light emitting diode, among the plurality of light emitting diodes ED1 and ED2.

The selection circuit SLC can include a plurality of selection transistors TP1 and TP2. The plurality of selection transistors TP1 and TP2 can include a first selection transistor TP1 and a second selection transistor TP2. The first selection transistor TP1 generates a current path of a first driving current which passes through the first light emitting diode ED1 and the second selection transistor TP2 generates a current path of a second driving current which passes through the second light emitting diode ED2.

The first selection transistor TP1 can be connected between the fourth node N4 and the first light emitting diode ED1 and a gate electrode of the first selection transistor TP1 can be connected to a first selection signal line which supplies a first selection signal Ss. When a pixel PX_2 to which a pixel circuit PC_2 is applied is driven in a first mode which is a wide field-of-view mode, the first selection signal Ss is supplied to the gate electrode of the first selection transistor TP1 to turn on the first selection transistor TP1. Therefore, a current path of the first driving current which passes through the first light emitting diode ED1 is formed so that the first light emitting diode ED1 can emit light. In the meantime, the first selection transistor TP1 can be referred to as a first emission control transistor which controls emission of the first light emitting diode ED1.

The second selection transistor TP2 can be connected between the fourth node N4 and the second light emitting diode ED2 and a gate electrode of the second selection transistor TP2 can be connected to a second selection signal line which supplies a second selection signal Ps. When a pixel PX_2 to which a pixel circuit PC_2 is applied is driven in a second mode which is a narrow field-of-view mode, the second selection signal Ps is supplied to the gate electrode of the second selection transistor TP2 to turn on the second selection transistor TP2. Therefore, a current path of the second driving current which passes through the second light emitting diode ED2 is formed so that the second light emitting diode ED2 can emit light. In the meantime, the second selection transistor TP2 can be referred to as a second emission control transistor which controls emission of the second light emitting diode ED2.

The first light emitting diode ED1 can be connected between the first selection transistor TP1 which is turned on or turned off by the first selection signal Ss and a low potential power line which supplies a low potential power voltage VSS. The second light emitting diode ED2 can be connected between the second selection transistor TP2 which is turned on or turned off by the second selection signal Ps and the low potential power line which supplies a low potential power voltage VSS.

In this case, the first light emitting diode ED1 or the second light emitting diode ED2 can be connected to another configuration of the pixel circuit PC_2, for example, the driving transistor DT, by the first selection transistor TP1 or the second selection transistor TP2 which is turned on according to a driving mode. For example, the first light emitting diode ED1 can be connected to the driving transistor DT via the first selection transistor TP1 which is turned on in the first mode and supply light by the first driving current, in the first mode, for example, in the wide field-of-view mode at a wide viewing angle which is a first viewing angle. Further, the second light emitting diode ED2 can be connected to the driving transistor DT via the second selection transistor TP2 which is turned on in the second mode and supply light by the second driving current, in the second mode, for example, in the narrow field-of-view mode at a narrow viewing angle which is a second viewing angle. Here, the driving mode can be specified by the user's input or determined when a predetermined condition is satisfied.

FIGS. 6A and 6B are waveform charts for explaining an example of an operation of the pixel of FIG. 5.

Here, in FIG. 6A, a waveform chart for explaining an example that the pixel PX_2 described with reference to FIG. 5 is driven in a first mode is illustrated and in FIG. 6B, a waveform chart for explaining an example that the pixel PX_2 described with reference to FIG. 5 is driven in a second mode is illustrated.

Referring to FIGS. 5 to 6B together, in the first mode, only the first light emitting diode ED1 can emit light and in the second mode, only the second light emitting diode ED2 can emit light. Here, as illustrated in FIG. 6A, the second selection signal Ps which controls the emission of the second light emitting diode ED2 to allow only the first light emitting diode ED1 to emit light in the first mode can be output only at a high level (or a first level) which is a turn-off level. Further, as illustrated in FIG. 6B, the first selection signal Ss which controls the emission of the first light emitting diode ED1 to allow only the second light emitting diode ED2 to emit light in the second mode can be output only at a high level which is a turn-off level.

Specifically, the first mode which is a wide field-of-view mode will be described with reference to FIGS. 5 and 6A. In an initialization period P1, a low level (or a second level, the second level is lower than the first level) of second scan signal SCAN2, a low level of first selection signal Ss, and a low level of emission signal EM can be output. The second transistor T2, the third sub transistor T4a, and the fourth sub transistor T4b can be turned on by the low level of second scan signal SCAN2 and the first selection transistor TP1 can be turned on by the low level of first selection signal Ss. Further, the third transistor T3 and the fifth transistor T5 can be turned on by the low level of emission signal EM.

The first node N1 can be initialized to the reference voltage Vref through the turned-on third transistor T3. A voltage of the anode electrode of the first light emitting diode ED1 and a voltage of the anode electrode of the second light emitting diode ED2 can be initialized to the reference voltage Vref, respectively, through the turned-on third sub transistor T4a and the turned-on fourth sub transistor T4b.

Further, the driving transistor DT forms a diode connection through the turned-on second transistor T2 to short the gate electrode and the drain electrode of the driving transistor DT so that the driving transistor DT can operate as a diode.

The reference voltage Vref which is transmitted to the anode electrode of the first light emitting diode ED1 through the turned-on third sub transistor T4a can be transmitted to the third node N3 and the second node N2 through the turned-on first selection transistor TP1 and the turned-on fifth transistor T5. Therefore, the third node N3 and the second node N2 can be initialized to the reference voltage Vref.

Next, during the sampling period P2, the low level of first scan signal SCAN1 and the low level of second scan signal SCAN2 can be output and the first selection signal Ss can be output at a high level. A high level of emission signal EM is output so that the third transistor T3 is turned off and the first transistor T1 is turned on by the low level of first scan signal SCAN1, simultaneously to transmit the data signal Vdata to the first node N1. The driving transistor DT is diode-connected by the turned-on second transistor T2 and a difference voltage of the high potential power voltage VDD and the threshold voltage is sampled to be supplied to the second node N2.

In the meantime, during the sampling period P2, the fifth transistor T5 can be turned off by the high level of emission signal EM and the first selection transistor TP1 can be turned off by the high level of first selection signal Ss.

Next, during a holding period P3, the first scan signal SCAN1 and the second scan signal SCAN2 are output at a high level and all the first transistor T1, the second transistor T2, the third sub transistor T4a, and the fourth sub transistor T4b can be turned off. However, even though the first transistor T1 is turned off, the data signal Vdata which has been input in the previous period (for example, a sampling period P2) can be maintained by the storage capacitor Cst.

Finally, during an emission period P4, the low level of first selection signal Ss and the low level of emission signal EM can be output and a high level of second selection signal Ps can be output. The reference voltage Vref is applied to the first node N1 through the third transistor T3 which is turned on by the low level of emission signal EM and the voltage of the first node N1 can become the difference voltage of the reference voltage Vref and the data signal Vdata. Such voltage fluctuation can be reflected to the second node N2. The gate-source voltage of the driving transistor DT can be set to a value Vdata−Vref+Vth obtained by subtracting the reference voltage Vref from the data signal Vdata and then adding threshold voltage Vth to control a first driving current.

A first driving current is supplied from the driving transistor DT to the first light emitting diode ED1 through the fifth transistor T5 which is turned on by the low level of emission signal EM and the first selection transistor TP1 which is turned on by the low level of first selection signal Ss. Therefore, the first light emitting diode ED1 can emit light. However, the second selection signal Ps is output at a high level to turn off the second selection transistor TP2 so that the second driving current from the driving transistor DT may not be transmitted to the second light emitting diode ED2. Accordingly, when the pixel PX_2 is driven in the first mode, the first driving current is applied only to the first light emitting diode ED1 so that only the first light emitting diode ED1 can emit light.

Next, the second mode which is a narrow field-of-view mode will be described with reference to FIGS. 4 and 6B. Except that the first selection signal Ss and the second selection signal Ps are output in an opposite manner as in the first mode which is a wide field-of-view mode, the pixel PX_2 can be driven in the second mode, in a substantially same manner as in the first mode. For example, the first selection signal Ss can be output only at a high level which is a turn-off level and the second selection signal Ps can be output at a low level which is a turn-on level during the emission period P4 in which the second light emitting diode ED2 emits light.

Specifically, during the initial period P1, the first scan signal SCAN1 can be output at a high level and the second scan signal SCAN2 can be output at a low level. The first selection signal Ss can be output at a high level and the second selection signal Ps and the emission signal EM can be output at a low level. Therefore, the second transistor T2, the third sub transistor T4a, and the fourth sub transistor T4b can be turned on by the second scan signal SCAN2 and the second selection transistor TP2 can be turned on by the second selection signal Ps, and the third transistor T3 and the fifth transistor T5 can be turned on by the emission signal EM.

The first node N1 can be initialized to the reference voltage Vref through the third transistor T3 which is turned on by the emission signal EM. The anode electrodes of the first light emitting diode ED1 and the second light emitting diode ED2 can be initialized to the reference voltage Vref by the third sub transistor T4a and the fourth sub transistor T4b which are turned on by the second scan signal SCAN2. The driving transistor DT is diode-connected through the turned-on second transistor T2 to operate as a diode. Finally, the reference voltage Vref which is transmitted to the anode electrode of the second light emitting diode ED2 through the turned-on fourth sub transistor T4b is transmitted to the third node N3 and the second node N2 through the turned-on second selection transistor TP2 and the turned on fifth transistor T5. Therefore, the third node N3 and the second node N2 can be initialized to the reference voltage Vref.

Next, during the sampling period P2, the low level of first scan signal SCAN1 and the low level of second scan signal SCAN2 can be output and the second selection signal Ps and the emission signal EM can be output at a high level from the low level. A high level of emission signal EM is output so that the third transistor T3 is turned off and the first transistor T1 is turned on by the low level of first scan signal SCAN1, simultaneously to transmit the data signal Vdata to the first node N1. The driving transistor DT is diode-connected by the turned-on second transistor T2 and a difference voltage of the high potential power voltage VDD and the threshold voltage is sampled to be supplied to the second node N2.

In the meantime, during the sampling period P2, the fifth transistor T5 can be turned off by the high level of emission signal EM and the second selection transistor TP2 can be turned off by the high level of second selection signal Ps.

Finally, during an emission period P4, the low level of second selection signal Ps and the low level of emission signal EM can be output and a high level of first selection signal Ss can be output. The reference voltage Vref can be applied to the first node N1 through the third transistor T3 which is turned on by the low level of emission signal EM and the voltage of the first node N1 can become the difference voltage of the reference voltage Vref and the data signal Vdata. Such voltage fluctuation can be reflected to the second node N2. The gate-source voltage of the driving transistor DT can be set to a value Vdata−Vref+Vth obtained by subtracting the reference voltage Vref from the data signal Vdata and then adding threshold voltage Vth control a second driving current.

A second driving current is supplied from the driving transistor DT to the second light emitting diode ED2 through the fifth transistor T5 which is turned on by the low level of emission signal EM and the second selection transistor TP2 which is turned on by the low level of second selection signal Ps. Therefore, the second light emitting diode ED2 can emit light. However, the first selection signal Ss is output at a high level to turn off the first selection transistor TP1 so that the first driving current from the driving transistor DT may not be transmitted to the first light emitting diode ED1. Accordingly, when the pixel PX_2 is driven in the second mode, the second driving current is applied only to the second light emitting diode ED2 so that only the second light emitting diode ED2 can emit light.

FIGS. 7 and 8 are cross-sectional views illustrating a part of a display device according to example embodiments of the present disclosure.

Particularly, FIGS. 7 and 8 illustrate a cross-sectional structure of a display device 1000 when a display panel 100 is used for a vehicle described with reference to FIG. 1 so that the display device 1000 is controlled to restrict a field of view of an image displayed in a specific region according to a driving mode, as described with reference to FIGS. 1 and 2, respectively. For example, FIG. 7 illustrates a cross-sectional structure of a display device 1000 including a pixel (for example, a pixel PX_2 of FIG. 5) in which a first optical member 161 is disposed. FIG. 8 illustrates a cross-sectional structure of a display device 1000 including a pixel (for example, a pixel PX_2 of FIG. 5) in which a second optical member 162 is disposed.

Referring to FIGS. 7 and 8, the display device 1000 according to the example embodiment of the present disclosure can include a substrate 110, a buffer film 111, a gate insulating film 112, an interlayer insulating film 113, a lower protection film 114, an overcoat layer 115, a bank insulating film 116, a first selection transistor TP1, a second selection transistor TP2, a first light emitting diode ED1, a second light emitting diode ED2, a first optical member 161, a second optical member 162, an optical member protection film 170, and an encapsulation member 180.

The substrate 110 can include an insulating material. The substrate 110 can include a transparent material. For example, the substrate 110 can include glass or plastic.

The buffer film 111 can be disposed on the substrate 110. The buffer film 111 can include an insulating material. For example, the buffer film 111 can include an inorganic insulating material, such as silicon oxide (SiOx) or silicon nitride (SiNx). The buffer film 111 can have a multi-layered structure. For example, the buffer film 111 can have a laminated structure of a film formed of silicon nitride (SiNx) and a film formed of silicon oxide (SiOx).

The buffer film 111 can be located between the substrate 110 and a driving part of each pixel PX_2. The buffer film 111 can suppress the contamination due to the substrate 110 in a process of forming the driving part. For example, a top surface of the substrate 110 which is directed to the driving part of each pixel PX_2 can be covered by the buffer film 111. The driving part of each pixel PX_2 can be located on the buffer film 111.

The gate insulating film 112 can be disposed on the buffer film 111. The gate insulating film 112 can include an insulating material. For example, the gate insulating film 112 can include an inorganic insulating material, such as silicon oxide (SiO) or silicon nitride (SiN). The gate insulating film 112 can include a material having a high permittivity. For example, the gate insulating film 112 can include a High-K material, such as hafnium oxide (HfO). The gate insulating film 112 can have a multi-layered structure.

The gate insulating film 112 can extend between the semiconductor layers 121 and 221 of the selection transistors TP1 and TP2 and the gate electrodes 122 and 223. For example, gate electrodes of the driving transistor and the switching transistor can be insulated from semiconductor layers of the driving transistor and the switching transistor by the gate insulating film 112. The gate insulating film 112 can cover the semiconductor layer of each pixel PX_2. The gate electrodes of the driving transistor and the switching transistor can be located on the gate insulating film 112.

The interlayer insulating film 113 can be disposed on the gate insulating film 112. The interlayer insulating film 113 can include an insulating material. For example, the interlayer insulating film 113 can include an inorganic insulating material, such as silicon oxide (SiO) or silicon nitride (SiN). The interlayer insulating film 113 can extend between the gate electrode and the source electrode of each of the driving transistor and the switching transistor and between the gate electrode and the drain electrode. For example, the source electrode and the drain electrode of each of the driving transistor and the switching transistor can be insulated from the gate electrode by the interlayer insulating film 113. The interlayer insulating film 113 can cover the gate electrode of each of the driving transistor and the switching transistor. The source electrode and the drain electrode of each pixel PX_2 can be located on the interlayer insulating film 113. The gate insulating film 112 and the interlayer insulating film 113 can expose a source region and a drain region of each semiconductor pattern which is located in each pixel PX_2.

The lower protection film 114 can be disposed on the interlayer insulating film 113. The lower protection film 114 can include an insulating material. For example, the lower protection film 114 can include an inorganic insulating material, such as silicon oxide (SiO) or silicon nitride (SiN). The lower protection film 114 can suppress the damage of the driving part due to the external moisture and shocks. The lower protection film 114 can extend along surfaces of the driving transistor and the switching transistor which are opposite to the substrate 110. The lower protection film 114 can be in contact with the interlayer insulating film 113 at the outside of the driving part located in each pixel PX_2.

The overcoat layer 115 can be disposed on the lower protection film 114. The overcoat layer 115 can include an insulating material. The overcoat layer 115 can include a material different from that of the lower protection film 114. For example, the overcoat layer 115 can include an organic insulating material. The overcoat layer 115 can remove a step caused by the driving part of each pixel PX_2. For example, a top surface of the overcoat layer 115 which is opposite to the substrate 110 can be a flat surface.

The first selection transistor TP1 and the second selection transistor TP2 can be disposed on the substrate 110. The first selection transistor TP1 can be electrically connected between the drain electrode of the driving transistor DT and the first lower electrode 141 of the first light emitting diode ED1. The second selection transistor TP2 can be electrically connected between the drain electrode of the driving transistor DT and the second lower electrode 151 of the second light emitting diode ED2.

The first selection transistor TP1 can include a first semiconductor layer 121, a first gate electrode 122, a first source electrode 123, and a first drain electrode 124. The first selection transistor TP1 can have the same structure as the switching transistor and the driving transistor. For example, the first semiconductor layer 121 can be located between the buffer film 111 and the gate insulating film 112 and the first gate electrode 122 can be located between the gate insulating film 112 and the interlayer insulating film 113. The first source electrode 123 and the first drain electrode 124 can be located between the interlayer insulating film 113 and the lower protection film 114. The first gate electrode 122 can overlap a channel region of the first semiconductor layer 121. The first source electrode 123 can be electrically connected to the source region of the first semiconductor layer 121. The first drain electrode 124 can be electrically connected to the drain region of the first semiconductor layer 121.

The second selection transistor TP2 can include a second semiconductor layer 221, a second gate electrode 223, a second source electrode 225, and a second drain electrode 227. For example, the second semiconductor layer 221 can be located on the same layer as the first semiconductor layer 121 and the second gate electrode 223 can be located on the same layer as the first gate electrode 122. The second source electrode 225 and the second drain electrode 227 can be located on the same layer as the first source electrode 123 and the first drain electrode 124.

The first light emitting diode ED1 and the second light emitting diode ED2 of each pixel PX_2 can be disposed on the overcoat layer 115 of the corresponding pixel PX_2.

The first light emitting diode ED1 can emit light representing a specific color. For example, the first light emitting diode ED1 can include a first lower electrode 141, a first emission layer 142, and a first upper electrode 143 which are sequentially laminated on the substrate 110.

The first lower electrode 141 can include a conductive material. The first lower electrode 141 can include a material having a high reflectance. For example, the first lower electrode 141 can include metal, such as aluminum (Al), and silver (Ag). The first lower electrode 141 can have a multi-layered structure. For example, the first lower electrode 141 can have a structure in which a reflective electrode formed of a metal is located between transparent electrodes formed of a transparent conductive material, such as ITO and IZO. The first lower electrode 141 can be electrically connected to the first drain electrode 124 of the first selection transistor TP1 through a contact hole which passes through the lower protection film 114 and the overcoat layer 115.

The first emission layer 142 can generate light with luminance corresponding to a voltage difference between the first lower electrode 141 and the first upper electrode 143. For example, the first emission layer 142 can include an emission material layer (EML) including an emission material. The emission material can include an organic material, an inorganic material, or a hybrid material.

The first emission layer 142 can have a multi-layered structure. For example, the first emission layer 142 can further include at least one of a hole injection layer HIL, a hole transport layer HTL, an electron transport layer ETL, and an electron injection layer EIL.

The first upper electrode 143 can include a conductive material. The first upper electrode 143 can include a different material from that of the first lower electrode 141. A transmittance of the first upper electrode 143 can be higher than a transmittance of the first lower electrode 141. For example, the first upper electrode 143 can be a transparent electrode formed of a transparent conductive material, such as ITO and IZO. Accordingly, in the display device 1000 according to the example embodiment of the present disclosure, light generated by the first emission layer 142 can be emitted through the first upper electrode 143.

The second light emitting diode ED2 can implement the same color as the first light emitting diode ED1. The second light emitting diode ED2 can have the same structure as the first light emitting diode ED1. For example, the second light emitting diode ED2 can include a second lower electrode 151, a second emission layer 152, and a second upper electrode 153 which are sequentially laminated on the substrate 110.

The second lower electrode 151 can correspond to the first lower electrode 141, the second emission layer 152 can correspond to the first emission layer 142, and the second upper electrode 153 can correspond to the first upper electrode 143. For example, the second lower electrode 151 can be formed for the second light emitting diode ED2 with the same structure as the first lower electrode 141 and this is the same for the second emission layer 152 and the second upper electrode 153. For example, the first light emitting diode ED1 and the second light emitting diode ED2 can be formed to have the same structure. However, it is not limited thereto and, in some cases, at least a partial configuration of the first light emitting diode ED1 and the second light emitting diode ED2 can be formed to be different.

The second emission layer 152 can be spaced apart from the first emission layer 142. Accordingly, the emission due to the leakage current can be suppressed.

According to the example embodiment, light is generated by only one of the first emission layer 142 and the second emission layer 152 by the user's choice or according to a predetermined condition.

The second lower electrode 151 of each pixel PX_2 can be spaced apart from the first lower electrode 141 of the corresponding pixel PX_2. For example, the bank insulating film 116 can be located between a first lower electrode 141 and a second lower electrode 151 of each pixel PX_2. The bank insulating film 116 can include an insulating material. For example, the bank insulating film 116 can include an organic insulating material. The bank insulating film 116 can include a material different from that of the overcoat layer 115.

The second lower electrode 151 of each pixel PX_2 can be insulated from the first lower electrode 141 of the corresponding pixel PX_2 by the bank insulating film 116. For example, the bank insulating film 116 can cover an edge of the first lower electrode 141 and an edge of the second lower electrode 151 located in each pixel PX_2. Accordingly, in the display device 1000, an image by a first optical area of each pixel PX_2 in which the first light emitting diode ED1 is located and an image by a second optical area of each pixel PX_2 in which the second light emitting diode ED2 is located can be provided to the user.

The first emission layer 142 and the first upper electrode 143 of the first light emitting diode ED1 located in each pixel PX_2 can be laminated on a partial area of the first lower electrode 141 exposed by the bank insulating film 116. The second emission layer 152 and the second upper electrode 153 of the second light emitting diode ED2 located in each pixel PX_2 can be laminated on a partial area of the second lower electrode 151 exposed by the bank insulating film 116. For example, the bank insulating film 116 can divide a first emission area in which light by the first light emitting diode ED1 is emitted and a second emission area in which light by the second light emitting diode ED2 is emitted in each pixel PX_2. A size of the second emission area which is divided in the pixel PX_2 can be smaller than a size of the first emission area.

The second upper electrode 153 of each pixel PX_2 can be electrically connected to the first upper electrode 143 of the corresponding pixel PX_2. For example, a voltage applied to the second upper electrode 153 of the second light emitting diode ED2 located in each pixel PX_2 can be equal to a voltage applied to the first upper electrode 143 of the first light emitting diode ED1 located in the pixel PX_2. The second upper electrode 153 of each pixel PX_2 can include the same material as the first upper electrode 143 of the corresponding pixel PX_2. For example, the second upper electrode 153 of each pixel PX_2 can be formed simultaneously with the first upper electrode 143 of the corresponding pixel PX_2. The second upper electrode 153 of each pixel PX_2 extends onto the bank insulating film 116 to be in direct contact with the first upper electrode 143 of the corresponding pixel PX_2. A luminance of a first optical area and a luminance of a second optical area located in each pixel PX_2 can be controlled by a driving current generated in the corresponding pixel PX_2.

The encapsulation member 180 can be located on the first light emitting diode ED1 and the second light emitting diode ED2 of each pixel PX_2. The encapsulation member 180 can suppress the damage of the plurality of light emitting diodes ED1 and ED2 due to moisture and shocks from the outside. The encapsulation member 180 can have a multi-layered structure. For example, the encapsulation member 180 can include a first encapsulation layer 181, a second encapsulation layer 182, and a third encapsulation layer 183 which are sequentially laminated, but it is not limited thereto. The first encapsulation layer 181, the second encapsulation layer 182, and the third encapsulation layer 183 can include an insulating material. The second encapsulation layer 182 can include a material different from those of the first encapsulation layer 181 and the third encapsulation layer 183. For example, the first encapsulation layer 181 and the third encapsulation layer 183 can be inorganic encapsulation layers including an inorganic insulating material and the second encapsulation layer 182 can include an organic encapsulation layer including an organic insulating material. Therefore, the plurality of light emitting diodes ED1 and ED2 can efficiently suppress the damage due to the moisture and shocks from the outside.

The first optical member 161 and the second optical member 162 can be disposed on the encapsulation member 180.

The first optical member 161 can be disposed on the first light emitting diode ED1. Light which is generated by the first light emitting diode ED1 of each pixel PX_2 can be emitted through the first optical member 161 which is disposed in the first optical area of the corresponding pixel PX_2. The first optical member 161 can have a shape that does not limit light of at least one direction. For example, a planar shape of the first optical member 161 located in each pixel PX_2 can have a bar shape extending in one direction.

In this case, a traveling direction of the light emitted from the first optical area of each pixel PX_2 may not be restricted to one direction. For example, contents (or images) provided through the first optical area of each pixel PX_2 can be shared by surrounding people who are adjacent to the user in one direction. Accordingly, the contents provided by the light emitted through the first optical member 161 can be provided in a first viewing angle range which is larger than a viewing angle of contents provided by the light emitted through the second optical member 162. For example, the content provided by the light emitted through the first optical member 161 can be provided in a wide field-of-view mode (share mode).

The second optical member 162 can be disposed on the second light emitting diode ED2. Light which is generated by the second light emitting diode ED2 of each pixel PX_2 can be emitted through the second optical member 162 which is disposed in the second optical area of the corresponding pixel PX_2. The second optical member 162 can restrict a traveling direction of passing light in one direction and/or the other direction. For example, a planar shape of the second optical member 162 located in each pixel PX_2 can be a circle.

In this case, a traveling direction of the light emitted from the second optical area of each pixel PX_2 can be limited to one direction and/or the other direction. For example, contents (or images) provided by the second optical area of each pixel PX_2 may not be shared by surrounding people of the user. Accordingly, the contents provided by the light emitted through the second optical member 162 can be provided in a second viewing angle range which is smaller than a viewing angle of contents provided by the light emitted through the first optical member 161. For example, the content provided by the light emitted through the second optical member 162 can be provided in a narrow field-of-view mode (private mode).

The first emission area of each pixel PX_2 can have a shape corresponding to the first optical member 161 of the corresponding pixel PX_2. For example, a planar shape of the first emission area of each pixel PX_2 can have a bar shape which extends in one direction. The first optical member 161 can have a size larger than the first emission area of the corresponding pixel PX_2. Accordingly, the efficiency of light discharged from the first emission area of the pixel PX_2 can be improved.

The second emission area of each pixel PX_2 can have a shape corresponding to the second optical member 162 of the corresponding pixel PX_2. For example, a planar shape of the second emission area of each pixel PX_2 can be a circle. The second optical member 162 can have a size larger than the second emission area of the corresponding pixel PX_2. Accordingly, the efficiency of light discharged from the second emission area of the pixel PX_2 can be improved.

An optical member protection film 170 can be located on the first optical member 161 and the second optical member 162 of the pixel PX_2. The optical member protection film 170 can include an insulating material. For example, the optical member protection film 170 can include an organic insulating material. A refractive index of the optical member protection film 170 can be smaller than a refractive index of the first optical member 161 and a refractive index of the second optical member 162 located in each pixel PX_2. Accordingly, light which passes through the first optical member 161 and the second optical member 162 of each pixel PX_2 may not be reflected toward the substrate 110 due to the refractive index difference from the optical member protection film 170.

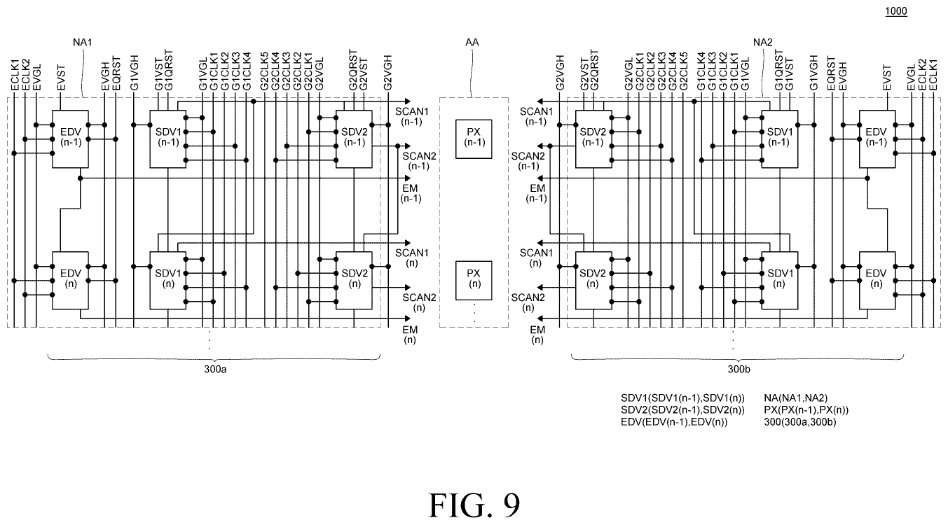

FIG. 9 is a view for explaining an example of a placement structure of a gate driver included in the display device of FIG. 2.

Referring to FIGS. 2 and 9, the display device 1000 according to the example embodiment of the present disclosure can include the plurality of pixels PX disposed in the active area AA and the gate driver 300 disposed in the non-active area NA.

In the example embodiment, as described with reference to FIG. 2, the gate driver 300 can be embedded on the non-active area NA of the display panel 100 in a GIP manner. For example, the gate driver 300 can include a first gate driver 300a disposed in the first non-active area NA1 located on one side of the active area AA, in the non-active area NA and a second gate driver 300b located in a second non-active area NA2 located in the other side of the active area AA. Accordingly, the first gate driver 300a and the second gate driver 300b supply the gate signal to the plurality of pixels PX disposed in the active area AA on both sides of the active area AA so that the voltage drop (IR drop) according to the load of the display panel 100 can be improved.

The gate driver 300, for example, the first gate driver 300a and the second gate driver 300b can supply the scan signal and the emission signal to the plurality of pixels PX disposed in the active area AA, respectively. For example, each of the first gate driver 300a and the second gate driver 300b can include a first scan driver SDV1 which outputs a first scan signal SCAN1, a second scan driver SDV2 which outputs a second scan signal SCAN2, and an emission signal driver EDV which outputs an emission signal EM.

According to the example embodiment, the second scan driver SDV2 can be disposed on the non-active area NA, for example, a non-active area NA which is the most adjacent to the active area AA, between the first non-active area NA1 and the second non-active area NA2. The emission driver EDV can be disposed in a non-active area NA which is the furthest from the active area AA. However, this is just exemplary so that the example embodiment of the present disclosure is not limited thereto.

The first scan driver SDV1 can supply the first scan signal SCAN1 to the plurality of pixels PX based on a first scan start signal G1VST (or a first scan signal output in a previous stage), a first scan reset signal G1QRST, first to fourth gate clock signals G1CLK1 to G1CLK4, a first gate power G1VGH, and a second gate power G1VGL. For example, the first scan driver SDV1 can sequentially output the first scan signal SCAN1 in a unit of pixel rows.

For example, an n−1-th (n is an integer larger than 1) stage (denoted by “SDV1(n−1)” in FIG. 9) of the first scan driver SDV1 can supply the first scan signal SCAN1(n−1) to a pixel (denoted by “PX(n−1)” in FIG. 9) disposed in an n−1-th row among the plurality of pixels PX. An n-th stage (denoted by “SDV1(n)” in FIG. 9) of the first scan driver SDV1 can supply the first scan signal SCAN1(n−1) to a pixel (denoted by “PX(n)” in FIG. 9) disposed in an n-th row among the plurality of pixels PX.

The second scan driver SDV2 can supply the second scan signal SCAN2 to the plurality of pixels PX based on a second scan start signal G2VST (or a second scan signal output from a previous stage), a second scan reset signal G2QRST, first to fifth gate clock signals G2CLK1 to G2CLK5, a third gate power G2VGH, and a fourth gate power G2VGL. For example, the second scan driver SDV2 can sequentially output the second scan signal SCAN2 in a unit of pixel rows.

For example, an n−1-th stage (denoted by “SDV2(n−1)” in FIG. 9) of the second scan driver SDV2 can supply a second scan signal SCAN2(n−1) to a pixel (denoted by “PX(n−1)” in FIG. 9) disposed in an n−1-th row, among the plurality of pixels PX. An n-th stage (denoted by “SDV2(n)” in FIG. 9) of the second scan driver SDV2 can supply a second scan signal SCAN2(n) to a pixel (denoted by “PX(n)” in FIG. 9) disposed in an n-th row, among the plurality of pixels PX.

The emission signal driver EDV can supply the emission signal EM to the plurality of pixels PX, based on an emission start signal EVST (or an emission signal output in a previous stage), an emission reset signal EQRST, first and second emission clock signals ECLK1 and ECLK2, a fifth gate power EVGH, and a sixth gate power EVGL. For example, the emission signal driver EDV can sequentially output the emission signal EM in the unit of pixel rows.

For example, an n−1-th stage (denoted by “EDV(n−1)” in FIG. 9) of the emission signal driver EDV can supply an emission signal EM(n−1) to a pixel (denoted by “PX(n−1)” in FIG. 9) disposed in an n−1-th row, among the plurality of pixels PX. An n-th stage (denoted by “EDV(n)” in FIG. 9) of the emission signal driver EDV can supply an emission signal EM(n) to a pixel (denoted by “PX(n)” in FIG. 9) disposed in an n-th row, among the plurality of pixels PX.

According to the example embodiment, the first gate power G1VGH supplied to the first scan driver SDV1, the third gate power G2VGH supplied to the second scan driver SDV2, and the fifth gate power EVGH supplied to the emission signal driver EDV can have the same power voltage, for example, a positive voltage level. Further, the second gate power G1VGL supplied to the first scan driver SDV1, the fourth gate power G2VGL supplied to the second scan driver SDV2, and the sixth gate power EVGL supplied to the emission signal driver EDV can have the same power voltage, for example, a negative voltage level. However, the present disclosure is not limited thereto.

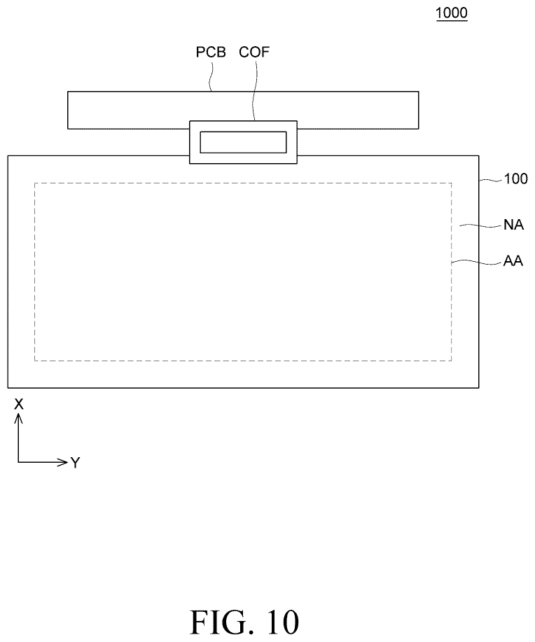

FIG. 10 is a plan view schematically illustrating a display device according to example embodiments of the present disclosure.

For the convenience of description, hereinafter, a vertical direction on the plain is illustrated as a first direction X and a horizontal direction on the plane is illustrated as a second direction Y. However, this is just example so that the first direction X and the second direction Y can be defined in various manners.

For the convenience of description, in FIG. 10, among various components of the display device 1000, only a display panel 100, a connection film COF, and a printed circuit board PCB are illustrated.

Referring to FIG. 10, the display device 1000 can include at least one connection film COF, at least one printed circuit board PCB, and a display panel 100.

The connection film COF can be disposed at one end of the display panel 100. For example, the connection film COF can be disposed at one end of the display panel 100 and can be electrically connected to a plurality of pads disposed in the display panel 100. The connection film COF can be a flexible film, but is not limited thereto.

In FIG. 10, even though it is illustrated that the display device 1000 includes one connection film COF, this is just illustrative, but the example embodiment of the present disclosure is not limited thereto. For example, the display device 1000 can include two or more connection films COF.

The connection film COF is a film in which various components are disposed on a base film having a ductility to supply a signal to the plurality of pixels PX and a driving circuit and can be electrically connected to the display panel 100. For example, the connection film COF can supply a power voltage, a data signal Vdata, and various signals to the plurality of pixels PX and the driving circuit.

In the example embodiment, a data driver 400, for example, a driving IC such as a data driver IC can be disposed on the connection film COF. The driving IC can correspond to a component which processes data for displaying images and a driving signal for processing the data. The driving IC can be disposed in a chip on glass (COG), a chip on film (COF), or a tape carrier package (TCP) manner depending on a mounting method. However, for the convenience of description, it is described that the driving IC is mounted on the connection film COF by a chip on film technique, but is not limited thereto. Further, the driving IC can be integrated with the timing controller 200 to be disposed as a single chip.

The printed circuit board PCB can be electrically connected to the connection film COF. The printed circuit board PCB can supply a signal to the driving IC mounted on the connection film COF. Various components can be disposed on the printed circuit board PCB to supply various signals such as a driving signal or a data signal to the driving IC.

In the meantime, in FIG. 10, even though it is illustrated that the display device 1000 includes one printed circuit board PCB, this is just illustrative, but the example embodiment of the present disclosure is not limited thereto. For example, the display device 1000 can include two or more printed circuit boards PCB.

The display panel 100 can include an active area AA and a non-active area NA which encloses the active area AA. On the active area AA of the display panel 100, a plurality of pixels PX which is disposed in a row direction and a column direction, for example, in the second direction Y and the first direction X is disposed to display images. Various components for driving the pixel circuit disposed in the pixel PX can be disposed in the non-active area of the display panel 100.

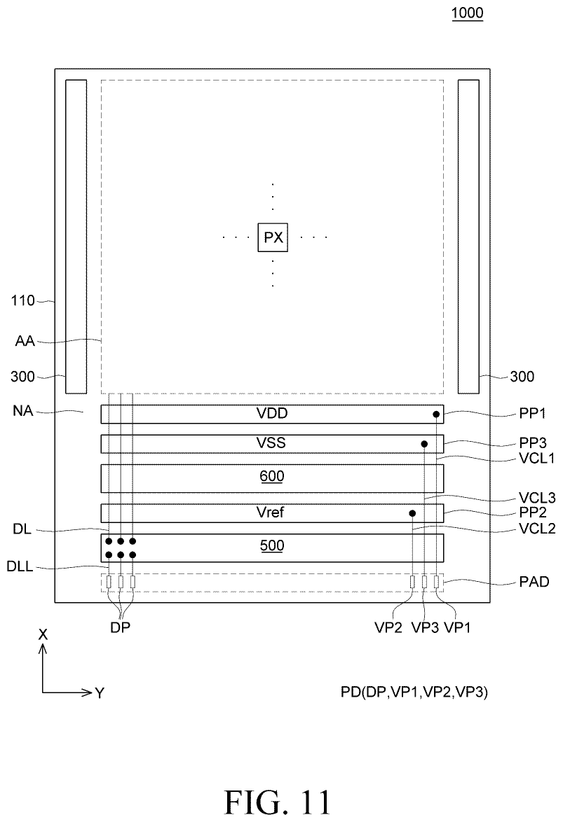

FIG. 11 is a plan view of a display device according to example embodiments of the present disclosure.

For the convenience of description, in FIG. 11, with respect to a plane defined along the first direction X and the second direction Y, one side of the display device 1000 along the first direction X is defined as a top or an upper side and one side of the display device 1000 along an opposite direction of the first direction X is defined as a bottom or a lower side.

Referring to FIGS. 10 and 11, the display device 1000 can include a substrate 110, a gate driver 300, a pad unit PAD, a plurality of power patterns PP1, PP2, and PP3, a de-multiplexer 500, a test circuit 600, and various signal lines.

The substrate 110 can include an active area AA and a non-active area NA enclosing the active area AA. For example, the non-active area NA can be disposed so as to enclose the active area AA.

Various components for driving a plurality of pixels PX included in the active area AA can be disposed in the non-display area NA. For example, on the non-active area NA of the substrate 110, the gate driver 300, the pad unit PAD, the plurality of power patterns PP1, PP2, and PP3, the de-multiplexer 500, the test circuit 600, and various signal lines can be disposed.

The gate driver 300 is disposed on the non-active area NA to supply a gate signal to the plurality of pixels PX disposed in the active area AA. For example, the gate driver 300 can supply a gate signal in the form of a shift register.

Further, on the non-active area NA of the substrate 110, two gate drivers 300 can be disposed on both sides of the active area AA. For example, two gate drivers 300 can supply a gate signal to the plurality of pixels PX disposed on the active area AA in a double feeding manner. For example, as described with reference to FIG. 9, the gate driver 300 can include a first gate driver 300a disposed on one side of the active area AA and a second gate driver 300b disposed on the other side of the active area AA. However, this is just exemplary, so that the present disclosure is not limited thereto and the display device 1000 can include only one gate driver 300 disposed on one side of the active area AA.

The pad unit PAD is disposed on a lowermost end of the non-active area NA of the substrate 110 and can include a plurality of pads PD. For example, the plurality of pads PD can include a plurality of data pads which supplies a data signal Vdata, a plurality of power pads VP1, VP2, and VP3 which supplies a power voltage to the plurality of power patterns PP1, PP2, and PP3, and a plurality of signal pads which supplies various signals. In the meantime, the pad unit PAD can be defined as a pad area in which various pads PD are disposed.

The plurality of pads PD included in the pad unit PAD is electrically connected to the connection film COF which has been described with reference to FIG. 10 to be supplied with various signals and various power voltages.

The plurality of power patterns PP1, PP2, and PP3 is disposed on the non-active area NA and is supplied with a power voltage from the plurality of power pads VP1, VP2, and VP3 to supply the power voltage to the plurality of pixels PX disposed in the active area AA. For example, the plurality of power patterns PP1, PP2, and PP3 can include a first power pattern PP1 which transmits a high potential power voltage VDD to the plurality of pixels PX, a second power pattern PP2 which transmits a reference voltage Vref to the plurality of pixels PX, and a third power pattern PP3 which transmits a low potential power voltage VSS to t the plurality of pixels PX. In the meantime, in the present disclosure, the term power pattern can be changed to a power line.

The first power pattern PP1 which supplies the high potential power voltage VDD can be disposed on a non-active area NA disposed on the bottom of the active area AA, of the non-active area NA. For example, the first power pattern PP1 can be disposed so as to be the most adjacent to the active area AA, in the non-active area NA located on the bottom of the active area AA.

The first power pattern PP1 can have a shape extending in the second direction Y.

Further, the first power pattern PP1 can be electrically connected to the first power pad VP1 included in the pad unit PAD through at least one first power connection line VCL1 (or a high potential power line) extending in the first direction X. Therefore, the first power pattern PP1 can be supplied with the high potential power voltage VDD from the first power pad VPL.

The second power pattern PP2 which supplies the reference voltage Vref can be disposed on a non-active area NA disposed on the bottom of the active area AA, of the non-active area NA. For example, the second power pattern PP2 can be disposed between the first power pattern PP1 and the pad unit PAD, in the non-active area NA located on the bottom of the active area AA.

The second power pattern PP2 can have a shape extending in the second direction Y. Further, the second power pattern PP2 can be electrically connected to the second power pad VP2 included in the pad unit PAD through at least one second power connection line VCL2 extending in the first direction X. Therefore, the second power pattern PP2 can be supplied with the reference voltage Vref from the second power pad VP2.

The third power pattern PP3 which supplies the low potential power voltage VSS can be disposed on a non-active area NA disposed on the bottom of the active area AA, of the non-active area NA. For example, the third power pattern PP3 can be disposed between the first power pattern PP1 and the second power pattern PP2, in the non-active area NA located on the bottom of the active area AA.

The third power pattern PP3 can have a shape extending in the second direction Y.

Further, the third power pattern PP3 can be electrically connected to the third power pad VP3 included in the pad unit PAD through at least one third power connection line VCL3 (or a low potential power line) extending in the first direction X. Therefore, the third power pattern PP3 can be supplied with the low potential power voltage VSS from the third power pad VP3.

In the meantime, in FIG. 11, it is described that the plurality of power patterns PP1, PP2, and PP3 is disposed on the non-active area NA located on the bottom of the active area AA, for example, on the non-active area NA in which the pad unit PAD is located. However, the example embodiment of the present disclosure is not limited thereto. For example, according to an example embodiment, at least one of the plurality of power patterns PP1, PP2, and PP3 can be disposed on the non-active area NA which is located on the top of the active area AA. Alternatively, the plurality of power patterns PP1, PP2, and PP3 can be disposed in each of the non-active area NA located on the top of the active area AA and the non-active area NA located on the bottom of the active area AA.

According to the example embodiment, the plurality of power patterns PP1, PP2, and PP3 can include a metal material having a good conductivity to supply the power voltage, but is not limited thereto.

However, the shape, the placement, and the connection relationship of the plurality of power patterns PP1, PP2, and PP3 which have been described above are just exemplary, and can vary in various forms depending on the design of the display device 1000.

In the meantime, as described with reference to FIG. 10, a data driver 400, for example, a driving IC such as a data driver IC can be disposed on the connection film COF. The data driver 400 disposed on the connection film COF can supply a data signal Vdata through the plurality of data pads DP included in the pad unit PAD.

Further, a plurality of data connection lines DLL which extends in the first direction X can be electrically connected to each of the plurality of data pads DP. Therefore, each of the plurality of data connection lines DLL can be provided with the data signal Vdata.

Each of the plurality of data connection lines DLL is connected to the de-multiplexer 500 to be electrically connected to one data line DL selected from the plurality of data lines DL disposed on the active area AA by the operation of the de-multiplexer 500 to transmit the data signal Vdata to the corresponding data line DL. At this time, the data signal Vdata can be supplied to the plurality of pixels PX disposed in the active area AA.

The de-multiplexer 500 can time-divide the data signal Vdata transmitted by the plurality of data connection lines DLL into a plurality of data lines DL. For example, the de-multiplexer 500 can electrically connect one data connection line DLL, of the plurality of data connection lines DLL, to the plurality of data lines DL disposed on the active area AA.

The de-multiplexer 500 can be disposed on the non-active area NA located below the active area AA, of the non-active area NA. For example, the de-multiplexer 500 can be disposed between the plurality of power patterns PP1, PP2, and PP3, for example, the third power pattern PP3 and the pad unit PAD.

The test circuit 600 can test whether there is the abnormal operation or a defect of the plurality of pixels PX disposed in the active area AA before shipment of the display device 1000. For example, the test circuit 600 can apply a test signal to each of the plurality of pixels PX and is supplied with a feedback signal from the plurality of pixels PX to test whether there is the abnormal operation or the defect of the pixel PX through the current of the feedback signal. To this end, the test circuit 600 can include at least one test switch.

Further, in order to test whether there is the abnormal operation or the defect of the plurality of pixels PX of the display device 1000, a test device to apply a test signal to each of the plurality of pixels PX can be used. For example, at least one input pin and an output pin included in the test device can be connected to the plurality of pads PD included in the pad unit PAD of the display device 1000. The test signal output from the test device can be supplied to the plurality of pixels PX from at least one input pin via a pad PD and the feedback signal from the plurality of pixels PX can be supplied to an output pin of the test device via the pad PD. Accordingly, the test device can test whether there is the abnormal operation or the defect of the pixel PX through a current value of the corresponding feedback signal.

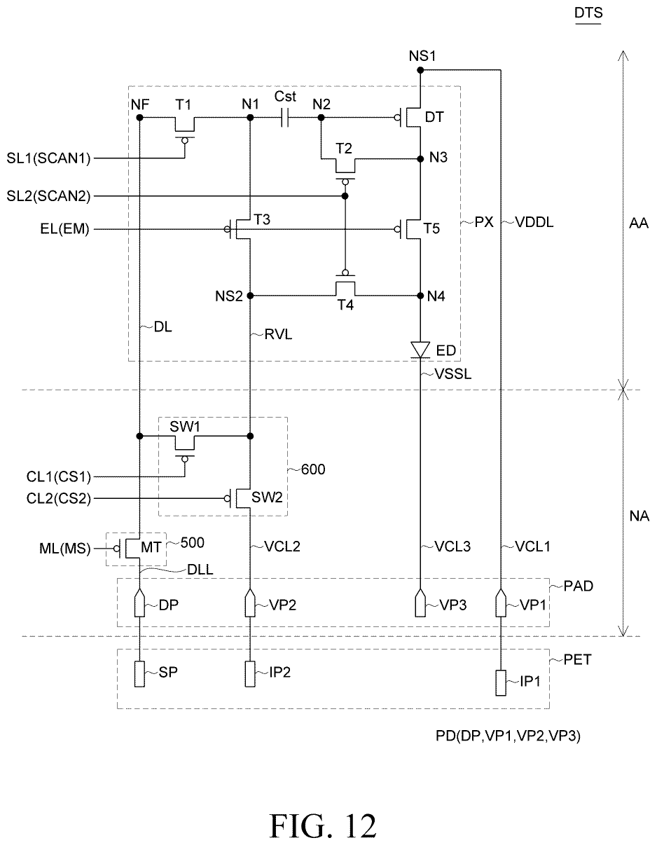

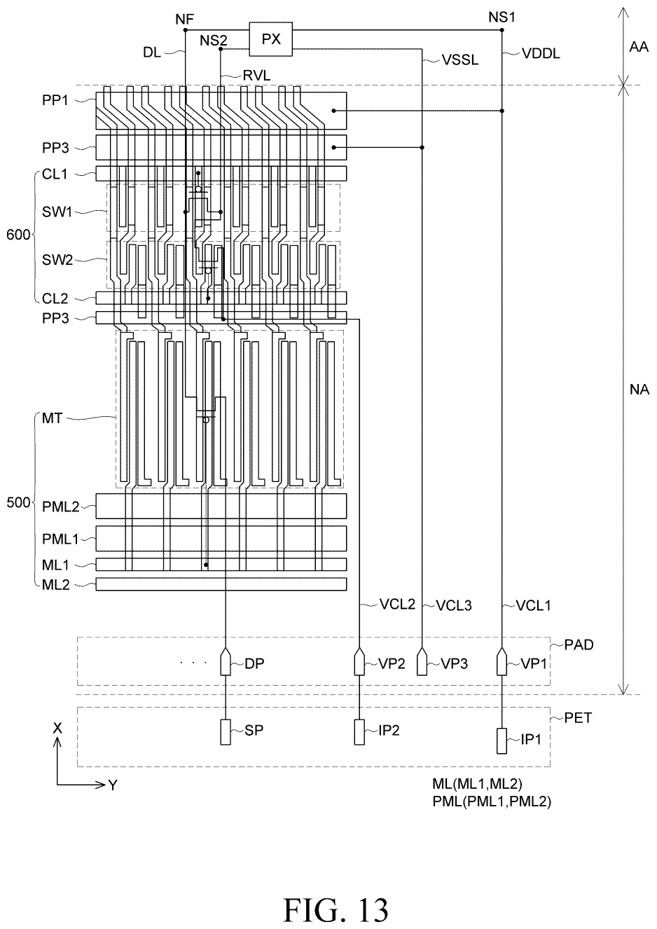

A test circuit 600 and a method for testing a pixel PX of the display device 1000 using a test device will be described in more detail with reference to FIGS. 12 and 13.

The test circuit 600 can be disposed on the non-active area NA located below the active area AA, of the non-active area NA. For example, the test circuit 600, for example, at least one test switch included in the test circuit 600 can be disposed between the second power pattern PP2 and the third power pattern PP3, but is not limited thereto.

FIGS. 12 and 13 are views illustrating a test system of a display device according to example embodiments of the present disclosure.

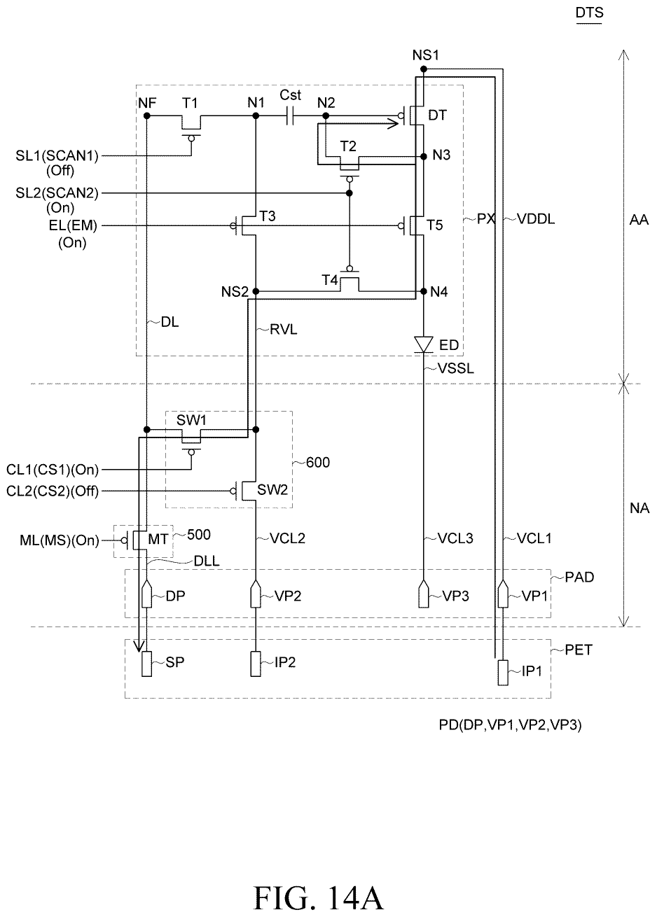

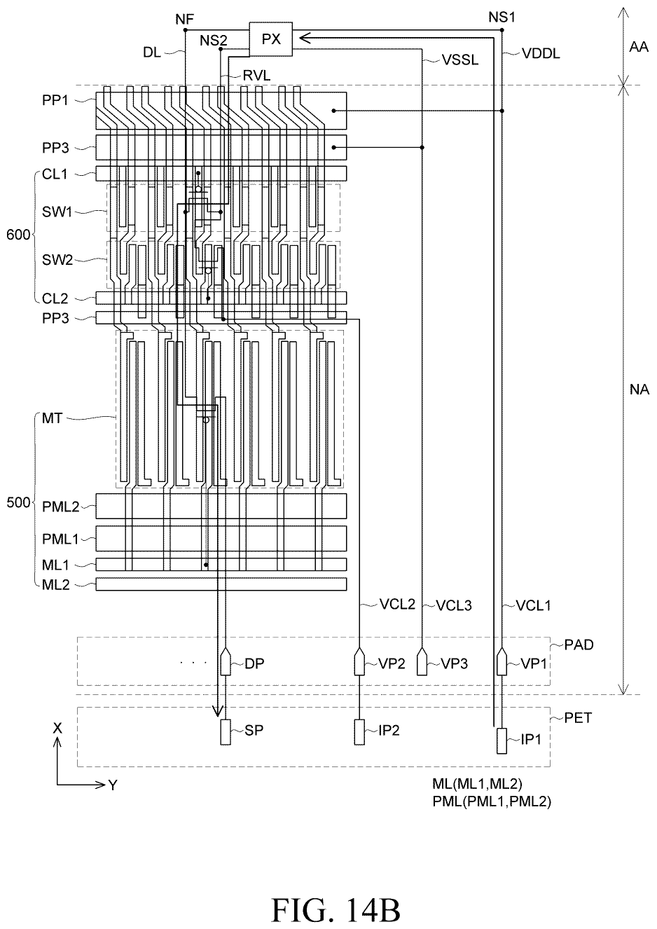

FIGS. 14A and 14B are views for explaining an example of an operation of testing a display device according to a first test mode by a test system of the display device of FIGS. 12 and 13.

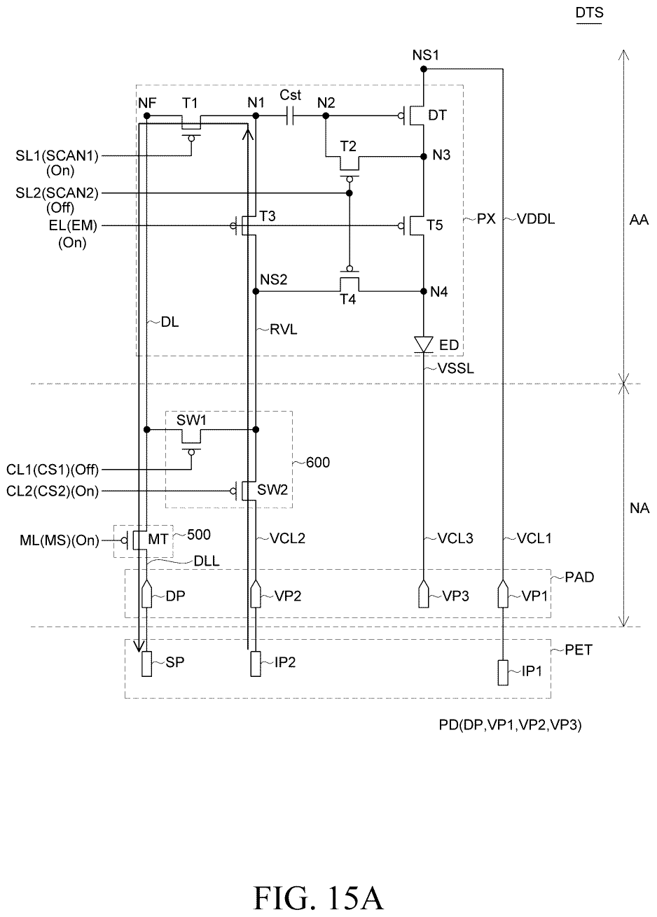

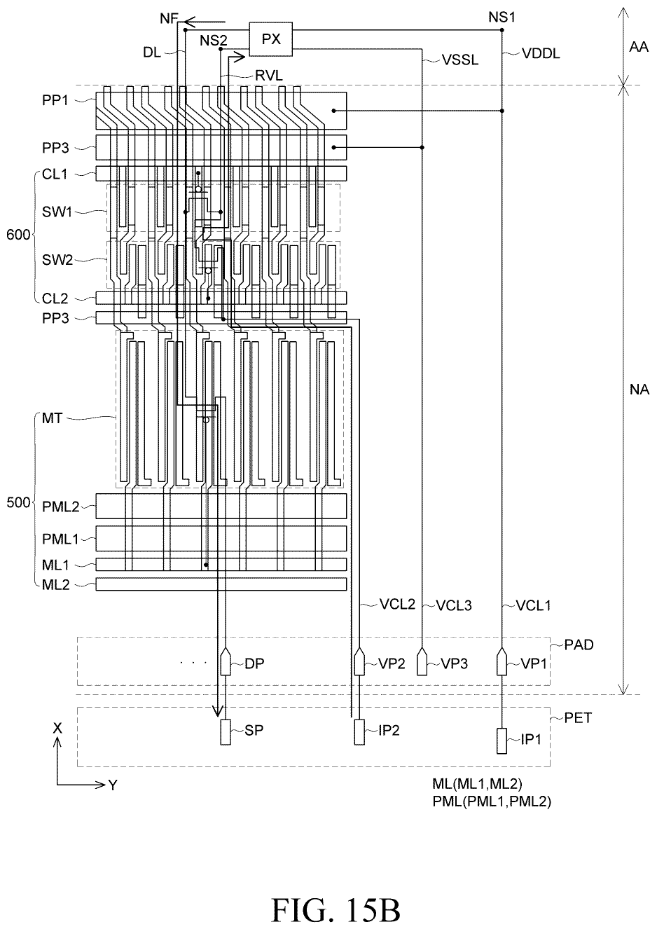

FIGS. 15A and 15B are views for explaining an example of an operation of testing a display device according to a second test mode by a test system of the display device of FIGS. 12 and 13.

For example, FIG. 12 illustrates an equivalent circuit diagram for a display device 1000 and a test device PET for testing the display device 1000, as a test system DTS of a display device according to example embodiments of the present disclosure.

For the convenience of description, in FIGS. 12 and 13, among various configurations of the display device 1000, only one pixel PX, a signal line connected to the pixel PX, a multiplexer (MUX) transistor MT of a de-multiplexer 500 connected to the pixel PX, first and second test switches SW1 and SW2 of a test circuit 600, and a plurality of pads PD connected to the pixel PX are illustrated. Further, input pins IP1 and IP2 and an output pin SP of the test device PET are illustrated.

Referring to FIGS. 10 to 13, the test system DTS of the display device according to the example embodiments of the present disclosure can include the display device 1000 and the test device PET which tests the display device 1000.

The pixel PX disposed in the active area AA of the display device 1000 can include a driving transistor DT, a plurality of transistors T1 to T5, a storage capacitor Cst, and a light emitting diode ED.

The corresponding pixel PX can be connected to a first scan line SL1 to which the first scan signal SCAN1 is supplied, a second scan line SL2 to which the second scan signal SCAN2 is supplied, and an emission signal line EL to which the emission signal EM is supplied, and a data line DL.

Further, the pixel PX can be connected to the plurality of pads PD included in the pad unit PAD. For example, as illustrated in FIG. 13, a first sensing node NS1 corresponding to one electrode of the driving transistor DT included in the pixel PX, for example, a source electrode can be connected to the first power pattern PP1 which supplies the high potential power voltage VDD through the high potential power line VDDL. Accordingly, the first sensing node NS1 of the pixel PX can be connected to the first power pad VP1 through the first power connection line VCL1 connected to the first power pattern PP1. Further, one electrode of the light emitting diode ED included in the pixel PX, for example, a cathode electrode can be connected to the third power pattern PP3 which supplies the low potential power voltage VSS through the low potential power line VSSL. Accordingly, the one electrode (cathode electrode) of the light emitting diode ED can be connected to the third power pad VP3 through the third power connection line VCL3 connected to the third power pattern PP3. The second sensing node NS2 corresponding to the reference voltage line RVL to which the third transistor T3 and the fourth transistor T4 of the pixel PX are commonly connected can be connected to the second power pattern PP2 which supplies the reference voltage Vref via the second test switch SW2 included in the test circuit 600. The second power pattern PP2 can be connected to the second power pad VP2 through the second power connection line VCL2.

The MUX transistor MT included in the de-multiplexer 500 can be connected between the pixel PX and the data pad DP. For example, the MUX transistor MT can be connected between the data line DL connected to the corresponding pixel PX and the data connection line DLL connected to the data pad DP. A gate electrode of the MUX transistor MT can be connected to a MUX line ML to which a MUX signal MS is supplied.

Accordingly, the MUX transistor MT is turned on when a gate-on level (for example, a low level) of MUX signal MS is supplied to the MUX line ML to connect the data connection line DLL and the data line DL (or connect the data pad DP and the pixel PX).

Referring to FIG. 13, the de-multiplexer 500 can be disposed on one side of the MUX transistor MT and include a plurality of MUX lines ML1 and ML2 and a plurality of pseudo lines PML1 and PML2 extending along the second direction Y. Here, the MUX transistor MT is connected to a corresponding MUX line ML (for example, a first MUX line ML1), among the plurality of MUX lines ML1 and ML2 to be supplied with a MUX signal MS.

In the meantime, each of the plurality of pseudo lines PML1 and PLM2 is not connected to the other configuration, but is open and a plurality of pseudo control signals can be supplied to each of the plurality of pseudo lines PML1 and PML2. For example, each of the plurality of pseudo control signals supplied to the plurality of pseudo lines PML1 and PML2 can have the same frequency as the plurality of MUX signals supplied to the plurality of MUX lines ML1 and ML2 and have an opposite phase. In this case, a falling edge of each of the plurality of MUX signals and a rising edge of each of the plurality of pseudo control signals can match and a rising edge of each of the plurality of MUX signals and a falling edge of each of the plurality of pseudo control signals can match. Accordingly, an electromagnetic wave noise (EMI noise) according to the MUX signal MS supplied to the plurality of MUX lines ML1 and ML2 of the de-multiplexer 500 can be improved.

In the meantime, in the present disclosure, a node through which the MUX transistor MT and the data line DL are connected or a node through which one electrode of the MUX transistor MT and one electrode of the first transistor T1 are connected can be defined as a feedback node NF.

The test circuit 600 controls at least one of whether the data line DL and the reference voltage line RVL are connected or whether the reference voltage line RVL and the second power pad VP2 are connected to control a current path of a test signal supplied from the input pins IP1 and IP2 of the test device PET. To this end, the test circuit 600 can include a first test switch SW1 and a second test switch SW2.

The first test switch SW1 can be connected between the data line DL (or the feedback node NF) and the reference voltage line RVL (or the second sensing node NS2) and include a gate electrode connected to the first control line CL to which the first control signal CS1 is supplied. Therefore, the first test switch SW1 is turned on when a gate-on level (for example, a low level) of first control signal CS1 is supplied to electrically connect the data line DL and the reference voltage line RVL (or the feedback node NF and the second sensing node NS2).

The second test switch SW2 can be connected between the reference voltage line RVL (or the second sensing node NS2) and the second power pad VP2 (or the second power connection line VCL2) and include a gate electrode connected to the second control line CL2 to which the second control signal CS2 is supplied. Therefore, the second test switch SW2 is turned on when a gate-on level (for example, a low level) of second control signal CS2 is supplied to electrically connect the reference voltage line RVL and the second power pad VP2 (or the second sensing node NS2 and the second power connection line VCL2).

According to the example embodiment, the first control line CL1 which supplies a first control signal CS1 applied to the gate electrode of the first test switch SW1 and the second control line CL2 which supplies a second control signal CS2 applied to the gate electrode of the second test switch SW2 are connected to a pad of an auto probe (A/P) device to be supplied with the first control signal CS1 and the second control signal CS2. For example, pads of the auto probe device are included in the test device PET and are connected to the pints which output the first control signal CS1 and the second control signal CS2 to supply the first control signal CS1 and the second control signal CS2 output from the test device PET to the first control line CL1 and the second control line CL2. However, the present disclosure is not limited thereto.

In the meantime, as illustrated in FIG. 13, the first test switch SW1 and the second test switch SW2 can be disposed to be spaced apart from each other along the first direction X. Further, the first control line CL1 connected to the first test switch SW1 extends in the second direction Y and can be disposed on one side of the first test switch SW1 which is opposite to the second test switch SW2. The second control line CL2 connected to the second test switch SW2 extends in the second direction Y and can be disposed on one side of the second test switch SW2 which is opposite to the first test switch SW1.

Referring to FIGS. 12 and 13, the test device PET of the test system DTS can supply a test signal to the pixel PX of the display device 1000 and test whether there is an abnormal operation or a defect of the pixel PX through the feedback signal output from the pixel PX.

To this end, in one example embodiment, the test device PET can include a first input pin IP1, a second input pin IP2, and an output pin SP.

The first input pin IP1 can be connected to the first power pad VP1, among the plurality of pads PD included in the pad unit PAD of the display device 1000. The first test signal which is output from the test device PET can be input to the first input pin IP1. Therefore, the first test signal can be supplied to the first power pad VP1 included in the pad unit PAD of the display device 1000 through the first input pin IP1.

The second input pin IP2 can be connected to the second power pad VP2, among the plurality of pads PD included in the pad unit PAD of the display device 1000. The second test signal which is output from the test device PET can be input to the second input pin IP2. Therefore, the second test signal can be supplied to the second power pad VP2 included in the pad unit PAD of the display device 1000 through the second input pin IP2.

The output pin SP can be connected to a data pad DP, among the plurality of pads PD included in the pad unit PAD of the display device 1000.

In one example embodiment, the test device PET of the test system DTS can test the display device 1000 in one test mode, between a first test mode and a second test mode, along a current path of the test signal (for example, a first test signal and a second test signal). A type of a transistor to be tested in the pixel PX included in the display device 1000 can be determined according to the current path of the test signal as described above.

According to the example embodiment, in the first test mode, only the first test switch SW1 can be turned on and in the second test mode, only the second test switch SW2 can be turned on. For example, in each of the first test mode and the second test mode, the first control signal CS1 and the second control signal CS2 can have different phases. For example, in the first test mode, the first control signal CS1 can have a gate-on level (for example, a low level) and reversely, the second control signal CS2 can have a gate-off level (for example, a high level). Contrary to this, in the second test mode, the second control signal CS2 can have a gate-on level (for example, a low level) and reversely, the first control signal CS1 can have a gate-off level (for example, a high level). Accordingly, during a period when the first test switch SW1 is turned on (for example, a period when the first test mode is driven), the second test switch SW2 can be maintained in a turned-off state at all times. Further, during a period when the second test switch SW2 is turned on (for example, a period when the second test mode is driven), the first test switch SW1 can be maintained in a turned-off state at all times.

In the first test mode, the test method of the test system DTS will be described in more detail with reference to FIGS. 14A and 14B. The test device PET of the test system DTS can supply the first test signal to the first input pin IP1 in the first test mode.

Further, in the first test mode, a gate-off level (denoted by “Off” in FIGS. 14A and 14B, for example, a high level) of first scan signal SCAN1 can be supplied to the first scan line SL1 and a gate-on level (denoted by “On” in FIGS. 14A and 14B, for example, a low level) of second scan signal SCAN2 can be supplied to the second scan line SL2. Further, a gate-on level (On) (for example, a low level) of emission signal EM can be supplied to the emission signal line EL.

Accordingly, in the first test mode, the driving transistor DT and the second to fifth transistors T2 to T5 included in the pixel PX can be turned on and the first transistor T1 can be turned off.

Further, in the first test mode, a gate-on level (On) (for example, a low level) of first control signal CS1 can be supplied to the first control line CL1 connected to the first test switch SW1 of the test circuit 600. A gate-off level (Off) (for example, a high level) of second control signal CS2 can be supplied to the second control line CL2 connected to the second test switch SW2 of the test circuit 600. Further, a gate-on level (On) (for example, a low level) of MUX signal MS can be supplied to the MUX line ML connected to the MUX transistor MT of the de-multiplexer 500.

Accordingly, in the first test mode, the first test switch SW1 included in the test circuit 600 and the MUX transistor MT included in the de-multiplexer 500 can be turned on and the second test switch SW2 included in the test circuit 600 can be turned off.

Accordingly, as illustrated in FIGS. 14A and 14B, the first test signal which is supplied to the first power pad VP1 through the first input pin IP1 of the test device PET flows through a first current path which passes through the driving transistor DT, the second transistor T2, the fifth transistor T5, the fourth transistor T4, the first test switch SW1, and the MUX transistor MT. Therefore, the first feedback signal along the first current path can be supplied to the output pin SP of the test device PET via the data pad DP.

Therefore, in the first test mode, the test system DTS (or the test device PET) according to the example embodiment of the present disclosure compares a current value of the first feedback signal and a current value of the first input signal to test whether there is an abnormal operation or a defect of the driving transistor DT, the second transistor T2, the fourth transistor T4, and the fifth transistor T5, among the plurality of transistors included in the pixel PX of the display device 1000.

In the meantime, in the first test mode, the second test signal is not supplied to the second input pin IP2. For example, in the first test mode, the second input pin IP2 and the second power pad VP2 connected thereto can be in an open state.

Next, in the second mode, the test method of the test system DTS will be described in more detail with reference to FIGS. 15A and 15B. The test device PET of the test system DTS can supply the second test signal to the second input pin IP2 in the second test mode.

Further, in the second test mode, a gate-on level (On) (for example, a low level) of first scan signal SCAN1 is supplied to the first scan line SL1 and a gate-off level (Off) (for example, a high level) of second scan signal SCAN2 is supplied to the second scan line SL2. Further, a gate-on level (On) (for example, a low level) of emission signal EM can be supplied to the emission signal line EL.

Accordingly, in the first test mode, the first, third, and fifth transistors T1, T3, and T5 included in the pixel PX can be turned on and the driving transistor DT, the second transistor T2, and the fourth transistor T4 can be turned off.

Further, in the second test mode, a gate-on level (On) (for example, a low level) of second control signal CS2 can be supplied to the second control line CL2 connected to the second test switch SW2 of the test circuit 600. A gate-off level (Off) (for example, a high level) of first control signal CS1 can be supplied to the first control line CL1 connected to the first test switch SW1 of the test circuit 600. Further, a gate-on level (On) (for example, a low level) of MUX signal MS can be supplied to the MUX line ML connected to the MUX transistor MT of the de-multiplexer 500.

Accordingly, in the second test mode, the second test switch SW2 included in the test circuit 600 and the MUX transistor MT included in the de-multiplexer 500 can be turned on and the first test switch SW1 included in the test circuit 600 can be turned off.

Accordingly, as illustrated in FIGS. 15A and 15B, the second test signal which is supplied to the second power pad VP2 through the second input pin IP2 of the test device PET flows through a second current path which passes through the second test switch SW2, the third transistor T3, the first transistor T1, and the MUX transistor MT. Therefore, the second feedback signal along the second current path can be supplied to the output pin SP of the test device PET via the data pad DP.

Therefore, in the second test mode, the test system DTS (or the test device PET) according to the example embodiment of the present disclosure compares a current value of the second feedback signal and a current value of the second input signal to test whether there is an abnormal operation or a defect of the first transistor T1 and the third transistor T3, among the plurality of transistors included in the pixel PX of the display device 1000.

In the meantime, in the second test mode, the first test signal is not supplied to the first input pin IP1. For example, in the second test mode, the first input pin IP1 and the first power pad VP1 connected thereto can be in an open state.

In the meantime, in each of the first test mode and the second test mode, the MUX transistor MT can be maintained in the turned-on state at all times for the first current path and the second current path. For example, in each of the first test mode and the second test mode, the MUX signal MS supplied to the MUX line ML connected to the MUX transistor MT can be maintained at a gate-on level (for example, a low level) at all times.

As described above, in the display device 1000 and the test system DTS of the display device according to the example embodiments of the present disclosure, the test signal can be supplied through at least one input pin IP1 and IP2 connected to the power pad (for example, the first power pad VP1 and the second power pad VP2), among the plurality of pads included in the display device 1000. Further, the feedback signal can be received through the output pin SP which is connected to the data pad DP via the pixel PX and whether there is an abnormal operation or a defect of the display device 1000 (for example, the pixel PX) can be tested based on a current value of the feedback signal. Here, the display device 1000 can include a test circuit 600 for controlling a current path of the test signal supplied from the input pins IP1 and IP2 of the test device PET according to the test mode.

Accordingly, the test system DTS of a display device according to the example embodiments of the present disclosure controls a signal level of various signals (for example, a first scan signal, a second scan signal, and an emission signal) applied to the pixel PX and control signals CS1 and CS2 which are supplied to a plurality of test switches SW1 and SW2 included in a test circuit 600. By doing this, the test system of a display device can test a pixel PX through a first feedback signal along a first current path or test a pixel PX through a second feedback signal along a second current path which is different from the first current path.

As described above, the test system DTS of the display device according to the example embodiments of the present disclosure can test whether there is an abnormal operation or a defect of all transistors DT, T1 to T5 included in the pixel PX of the display device 1000 using a feedback signal along various current paths.

A display device according to the example embodiments of the present disclosure can also be described as follows:

A display device according to an example embodiment of the present disclosure includes a display panel which is connected to a data line, a high potential power line, a low potential power line, and a reference voltage line and has a pixel including a driving transistor and a plurality of transistors disposed, a pad unit which includes a data pad connected to the data line, a first power pad connected to the high potential power line, a second power pad connected to the reference voltage line, and a third power pad connected to the low potential power line and a test circuit configured to control at least one of whether the reference voltage line is electrically connected to the data line and whether the reference voltage line is electrically connected to the second power pad.

The test circuit can include a first test switch which is connected between the data line and the reference voltage line and includes a gate electrode connected to a first control line to which a first control signal is supplied and a second test switch which is connected between the reference voltage line and the second power pad and includes the gate electrode connected to a second control line to which a second control signal is supplied.

The first control signal and the second control signal can have different phases.

During a period when the first test switch is turned on, the second test switch can be maintained in a turned-off state and during a period when the second test switch is turned on, the first test switch can be maintained in the turned-off state.

The display device can further include a MUX transistor which is connected between the data line and the data pad and includes the gate electrode connected to a MUX line to which a MUX signal is supplied.

The MUX transistor can be maintained in a turned-on state.

The pixel can include a light emitting diode, a driving transistor configured to control a driving current flowing from the high potential power line to the low potential power line via the light emitting diode, a first transistor which is connected between a first node and the data line and includes the gate electrode connected to a first scan line to which a first scan signal is supplied, a second transistor which is connected between a second node corresponding to the gate electrode of the driving transistor and a third node corresponding to a drain electrode of the driving transistor and includes the gate electrode connected to a second scan line to which a second scan signal is supplied, a third transistor which is connected between the first node and the reference voltage line and includes the gate electrode connected to an emission signal line to which an emission signal is supplied, a fourth transistor which is connected between the reference voltage line and a fourth node corresponding to one electrode of the light emitting diode and includes the gate electrode connected to the second scan line, a fifth transistor which is connected between the third node and the fourth node and includes the gate electrode connected to the emission signal line and a storage capacitor connected between the first node and the second node.

A test system of a display device or a testing system for a display device according to the example embodiments of the present disclosure can also be described as follows:

A test system of a display device according to an example embodiment of the present disclosure includes a display panel which is connected to a data line, a high potential power line, a low potential power line, and a reference voltage line and has a pixel including a driving transistor and a plurality of transistors disposed, a pad unit which includes a data pad connected to the data line, a first power pad connected to the high potential power line, a second power pad connected to the reference voltage line, and a third power pad connected to the low potential power line and a test device connected to the pad unit, wherein the test device includes a first input pin which is connected to the first power pad and is applied with a first test signal, a second input pin which is connected to the second power pad and is applied with a second test signal and an output pin connected to the data pad.

In a first test mode, the first test signal is supplied to the first input pin and the second input pin can be maintained in an open state, and in a second test mode which is different from the first test mode, the second test signal is supplied to the second input pin and the first input pin can be maintained in the open state.

The test system of the display device can further include a test circuit configured to control at least one of whether the data line and the reference voltage line are connected and whether the reference voltage line and the second power pad are connected.

The test circuit can include a first test switch which is connected between the data line and the reference voltage line and includes a gate electrode connected to a first control line to which a first control signal is supplied and a second test switch which is connected between the reference voltage line and the second power pad and includes the gate electrode connected to a second control line to which a second control signal is supplied.

The first control signal and the second control signal can have different phases.

In a first test mode, the first test switch can be maintained in a turned-on state and the second test switch can be maintained in a turned-off state, and in a second test mode which is different from the first test mode, the second test switch can be maintained in the turned-on state and the first test switch can be maintained in the turned-off state.

The test system of the display device can further include a MUX transistor which is connected between the data line and the data pad and includes the gate electrode connected to a MUX line to which a MUX signal is supplied.

The pixel can include a light emitting diode, a driving transistor configured to control a driving current flowing from the high potential power line to the low potential power line via the light emitting diode, a first transistor which is connected between a first node and the data line and includes the gate electrode connected to a first scan line to which a first scan signal is supplied, a second transistor which is connected between a second node corresponding to the gate electrode of the driving transistor and a third node corresponding to a drain electrode of the driving transistor and includes the gate electrode connected to a second scan line to which a second scan signal is supplied, a third transistor which is connected between the first node and the reference voltage line and includes the gate electrode connected to an emission signal line to which an emission signal is supplied, a fourth transistor which is connected between the reference voltage line and a fourth node corresponding to one electrode of the light emitting diode and includes the gate electrode connected to the second scan line, a fifth transistor which is connected between the third node and the fourth node and includes the gate electrode connected to the emission signal line and a storage capacitor connected between the first node and the second node.

In a first test mode, the second scan signal, the emission signal, the first control signal, and the MUX signal can have a gate-on level and the first scan signal and the second control signal can have a gate-off level and in a second test mode which is different from the first test mode, the first scan signal, the emission signal, the second control signal, and the MUX signal can have the gate-on level and the second scan signal and the first control signal can have the gate-off level.

Although the exmaple embodiments of the present disclosure have been described in detail with reference to the accompanying drawings, the present disclosure is not limited thereto and can be embodied in many different forms without departing from the technical concept of the present disclosure. Therefore, the example embodiments of the present disclosure are provided for illustrative purposes only but not intended to limit the technical concept of the present disclosure. The scope of the technical concept of the present disclosure is not limited thereto. Therefore, it should be understood that the above-described example embodiments are illustrative in all aspects and do not limit the present disclosure. The protective scope of the present disclosure should be construed based on the following claims, and all the technical concepts in the equivalent scope thereof should be construed as falling within the scope of the present disclosure.

What is claimed is:

1. A display device, comprising:
a display panel which is connected to a data line, a high potential power line, a low potential power line, and a reference voltage line and has a pixel including a driving transistor and a plurality of transistors;
a pad unit which includes a data pad connected to the data line, a first power pad connected to the high potential power line, a second power pad connected to the reference voltage line, and a third power pad connected to the low potential power line; and
a test circuit configured to electrically connect the reference voltage line to the data line or electrically connect the reference voltage line to the second power pad.

2. The display device according to claim 1, wherein the test circuit includes:
a first test switch which is connected between the data line and the reference voltage line and includes a gate electrode connected to a first control line to which a first control signal is supplied; and
a second test switch which is connected between the reference voltage line and the second power pad and includes the gate electrode connected to a second control line to which a second control signal is supplied.

3. The display device according to claim 2, wherein the first control signal and the second control signal have different phases.

4. The display device according to claim 2, wherein during a period when the first test switch is turned on, the second test switch is maintained in a turned-off state, and
wherein during a period when the second test switch is turned on, the first test switch is maintained in a turned-off state.

5. The display device according to claim 2, further comprising:
a multiplexer (MUX) transistor which is connected between the data line and the data pad and includes the gate electrode connected to a MUX line to which a MUX signal is supplied.

6. The display device according to claim 5, wherein the MUX transistor is maintained in a turned-on state.

7. The display device according to claim 5, wherein the pixel includes:
a light emitting diode;
a driving transistor configured to control a driving current flowing from the high potential power line to the low potential power line via the light emitting diode;
a first transistor which is connected between a first node and the data line and includes the gate electrode connected to a first scan line to which a first scan signal is supplied; and
a second transistor which is connected between a second node corresponding to the gate electrode of the driving transistor and a third node corresponding to a drain electrode of the driving transistor and includes the gate electrode connected to a second scan line to which a second scan signal is supplied.

8. The display device according to claim 7, wherein the pixel further includes:
a third transistor which is connected between the first node and the reference voltage line and includes the gate electrode connected to an emission signal line to which an emission signal is supplied;
a fourth transistor which is connected between the reference voltage line and a fourth node corresponding to one electrode of the light emitting diode and includes the gate electrode connected to the second scan line;
a fifth transistor which is connected between the third node and the fourth node and includes the gate electrode connected to the emission signal line; and
a storage capacitor connected between the first node and the second node.

9. A test system of a display device, the test system comprising:
a display panel which is connected to a data line, a high potential power line, a low potential power line, and a reference voltage line and has a pixel including a driving transistor and a plurality of transistors;
a pad unit which includes a data pad connected to the data line, a first power pad connected to the high potential power line, a second power pad connected to the reference voltage line, and a third power pad connected to the low potential power line; and
a test device connected to the pad unit,
wherein the test device includes:
a first input pin which is connected to the first power pad and is applied with a first test signal;
a second input pin which is connected to the second power pad and is applied with a second test signal; and
an output pin connected to the data pad.

10. The test system of the display device according to claim 9, wherein in a first test mode, the first test signal is supplied to the first input pin and the second input pin is maintained in an open state, and
wherein in a second test mode which is different from the first test mode, the second test signal is supplied to the second input pin and the first input pin is maintained in the open state.

11. The test system of the display device according to claim 9, further comprising:
a test circuit configured to control at least one of whether the data line and the reference voltage line are connected and whether the reference voltage line and the second power pad are connected.

12. The test system of the display device according to claim 11, wherein the test circuit includes:
a first test switch which is connected between the data line and the reference voltage line and includes a gate electrode connected to a first control line to which a first control signal is supplied; and
a second test switch which is connected between the reference voltage line and the second power pad and includes the gate electrode connected to a second control line to which a second control signal is supplied.

13. The test system of the display device according to claim 12, wherein the first control signal and the second control signal have different phases.

14. The test system of the display device according to claim 12, wherein in a first test mode, the first test switch is maintained in a turned-on state and the second test switch is maintained in a turned-off state, and
wherein in a second test mode which is different from the first test mode, the second test switch is maintained in a turned-on state and the first test switch is maintained in a turned-off state.

15. The test system of the display device according to claim 12, further comprising:
a multiplexer (MUX) transistor which is connected between the data line and the data pad and includes the gate electrode connected to a MUX line to which a MUX signal is supplied.

16. The test system of the display device according to claim 15, wherein the pixel includes:
a light emitting diode;
a driving transistor which controls a driving current flowing from the high potential power line to the low potential power line via the light emitting diode;
a first transistor which is connected between a first node and the data line and includes the gate electrode connected to a first scan line to which a first scan signal is supplied; and
a second transistor which is connected between a second node corresponding to the gate electrode of the driving transistor and a third node corresponding to a drain electrode of the driving transistor and includes the gate electrode connected to a second scan line to which a second scan signal is supplied.

17. The test system of the display device according to claim 16, wherein the pixel further includes:
a third transistor which is connected between the first node and the reference voltage line and includes the gate electrode connected to an emission signal line to which an emission signal is supplied;
a fourth transistor which is connected between the reference voltage line and a fourth node corresponding to one electrode of the light emitting diode and includes the gate electrode connected to the second scan line;
a fifth transistor which is connected between the third node and the fourth node and includes the gate electrode connected to the emission signal line; and
a storage capacitor connected between the first node and the second node.

18. The test system of the display device according to claim 17, wherein in a first test mode, the second scan signal, the emission signal, the first control signal, and the MUX signal have a gate-on level and the first scan signal and the second control signal have a gate-off level.

19. The test system of the display device according to claim 18, wherein in a second test mode which is different from the first test mode, the first scan signal, the emission signal, the second control signal, and the MUX signal have the gate-on level and the second scan signal and the first control signal have the gate-off level.
